(19) United States
(12) Patent Application Publication
(10) Pub. No.: US 2019/0351740 A1
(43) Pub. Date: Nov. 21, 2019

(54) USE OF AN INSIDE CONDENSER TO MAXIMIZE TOTAL THERMAL SYSTEM PERFORMANCE

(71) Applicant: NIO USA, Inc., San Jose, CA (US)

(72) Inventors: Matthew S. Filipkowski, Pleasanton, CA (US); Joshua Smith, Los Gatos, CA (US); Rick Rajaie, Rochester Hills, MI (US)

(21) Appl. No.: 15/983,285

(22) Filed: May 18, 2018

(51) Int. Cl. B60H 1/00

(52) U.S. Cl. CPC B60H 1/00921

(57) ABSTRACT

A thermal management system comprises a refrigerant loop that includes an inside condenser and an outside condenser. The inside condenser is configured to provide supplemental cooling to refrigerant in the refrigerant loop so that the outside condenser can operate at a mass flow rate that yields optimal efficiency. An inside condenser bypass line is used to route enough refrigerant around the inside condenser to allow the inside condenser to also operate at a mass flow rate that yields optimal efficiency.

### FIELD

The present disclosure is generally directed toward vehicle cooling systems, and more particularly, toward cooling systems for electric and/or hybrid-electric vehicles.

### BACKGROUND

Thermal management through liquid coolant circuits is vital for electric vehicle operation. Liquid cooling systems transfer thermal energy to, from, and/or between the batteries, motors, inverters, and other temperature-sensitive vehicle components and the vehicle's heat exchangers, so as to maintain the temperature of each component (and of the liquid coolant) within operational limits. Failure of a vehicle's liquid cooling system could cause vehicle components to shut down, malfunction, or be destroyed, any one of which occurrences could compromise the safety of the vehicle's occupants.

Highly complex liquid cooling systems comprising large numbers of pumps, valves, and sensors are typically required to ensure that each temperature-sensitive component within an electric or hybrid-electric vehicle is properly cooled. The criticality of such liquid cooling systems to proper vehicle operation further necessitates that redundancies be built into the system, which further elevates the complexity thereof. Moreover, vehicle thermal management systems are sized to meet the worst-case expected conditions, resulting in large, over-sized components that are typically used (or used to capacity) only a small percentage of the time.

U.S. Patent Application Publication No. 2017/0174037, entitled “Thermal reduction system for an automated vehicle,” published Jun. 22, 2017, and naming Meyhofer et al. as inventors, describes a cooling system for a data processing system housed in a cooling rack of an automated vehicle. Except to the extent the teachings of the foregoing document conflicts with the present disclosure, Applicant incorporates the entirety of the foregoing document herein by reference.

### BRIEF DESCRIPTION OF THE DRAWINGS

FIG. 1 shows a vehicle in accordance with embodiments of the present disclosure;

FIG. 2 shows a bottom plan view of the vehicle in accordance with at least some embodiments of the present disclosure;

FIG. 3 shows a top plan view of the vehicle in accordance with embodiments of the present disclosure;

FIG. 4 is a block diagram illustrating an exemplary communication environment of the vehicle in accordance with embodiments of the present disclosure;

FIG. 5 is a diagram of a thermal management system in accordance with embodiments of the present disclosure;

FIG. 6 is a block diagram of a control device for a thermal management system in accordance with embodiments of the present disclosure;

FIG. 7 is a flowchart of a method in accordance with embodiments of the present disclosure;

FIG. 8 is a diagram of a thermal management system or portion thereof in accordance with embodiments of the present disclosure;

FIG. 9A is a flowchart of a method in accordance with embodiments of the present disclosure;

FIG. 9B is a flowchart of another method in accordance with embodiments of the present disclosure; and

FIG. 10 is a flowchart of yet another method in accordance with embodiments of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

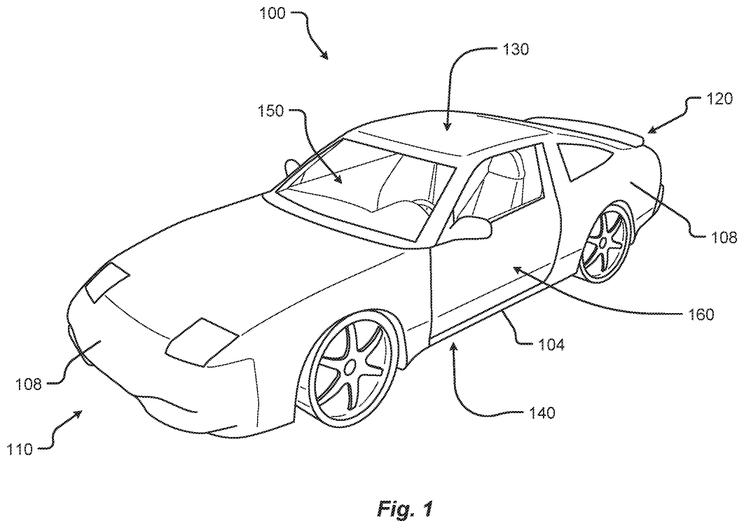

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

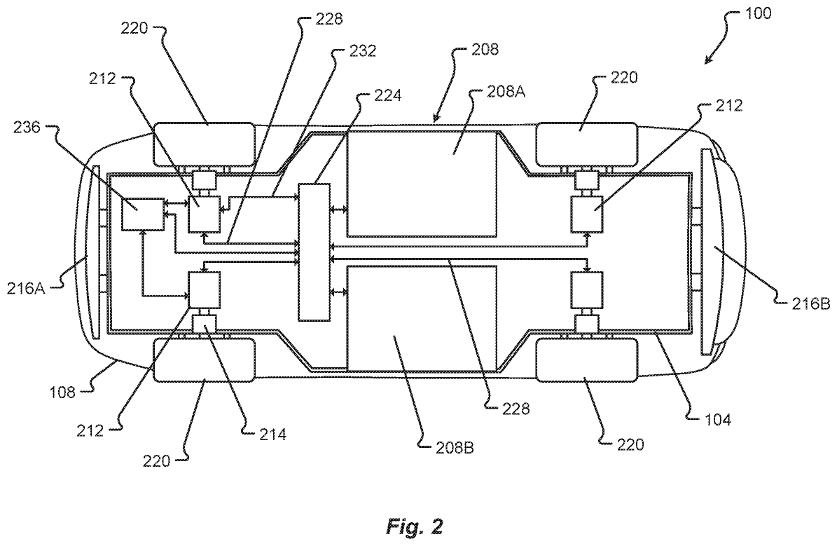

Referring now to FIG. 2, a plan view of a vehicle 100 will be described in accordance with embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 104 of the vehicle 100. The frame 104 may comprise a separate frame and body construction (i.e., body-on-frame construction), a unitary frame and body construction (i.e., a unibody construction), or any other construction defining the structure of the vehicle 100. The frame 104 may be made from one or more materials including, but in no way limited to steel, titanium, aluminum, carbon fiber, plastic, polymers, etc., and/or combinations thereof. In some embodiments, the frame 104 may be, for example, formed, welded, fused, fastened, pressed, combinations thereof, or otherwise shaped to define a physical structure and strength of the vehicle 100. In any event, the frame 104 may comprise one or more surfaces, connections, protrusions, cavities, mounting points, tabs, slots, or other features that are configured to receive other components that make up the vehicle 100. For example, the body panels 108, powertrain subsystem, controls systems, interior components, communications subsystem, and safety subsystem may interconnect with, or attach to, the frame 104 of the vehicle 100.

The frame 104 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allow the vehicle 100 to adapt to the ever-changing technological demands of society and advances in safety. Among other things, the mechanisms may provide for the quick exchange of, for example, batteries, capacitors, power sources 208A, 208B, motors 212, engines, safety equipment, controllers, user interfaces, interior or exterior components, body panels 108, bumpers 216, sensors, and/or combinations thereof. Additionally or alternatively, the mechanisms may provide unique security hardware and/or software embedded therein that, among other things, can prevent fraudulent or low quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single-minute exchange (“SME”) principle. In some embodiments, for example, the frame 104 may include slides, receptacles, cavities, protrusions, and/or a number of other features that allow for quick exchange of system components. In one embodiment, the frame 104 may include, for example, tray or ledge features, mechanical interconnection features, locking mechanisms, retaining mechanisms, and/or combinations thereof. In some embodiments, it may be beneficial to quickly remove a used power source 208A, 208B (e.g., battery unit, capacitor unit) from the vehicle 100 and replace the used power source 208A, 208B with a charged or new power source. Continuing this example, the power source 208A, 208B may include selectively interchangeable features that interconnect with the frame 104 or other portion of the vehicle 100. For instance, in a power source 208A, 208B replacement, the quick release features may be configured to release the power source 208A, 208B from an engaged position and slide or move in a direction away from the frame 104 of a vehicle 100. Once removed, or separated from, the vehicle, the power source 208A, 208B may be replaced (e.g., with a new power source, a charged power source, etc.) by engaging the replacement power source into a system receiving position adjacent to the vehicle 100. In some embodiments, the vehicle 100 may include one or more actuators configured to position, lift, slide, or otherwise engage the replacement power source with the vehicle 100. In one embodiment, the replacement power source may be inserted into the vehicle 100 or vehicle frame 104 with mechanisms and/or machines that are external and/or separate from the vehicle 100.

In some embodiments, the frame 104 may include one or more features configured to selectively interconnect with other vehicles and/or portions of vehicles. These selectively interconnecting features can allow for one or more vehicles to selectively couple together and decouple for a variety of purposes. For example, it is an aspect of the present disclosure that a number of vehicles may be selectively coupled together to share energy, increase power output, provide security, decrease power consumption, provide towing services, and/or provide a range of other benefits. Continuing this example, the vehicles may be coupled together based on travel route, destination, preferences, settings, sensor information, and/or some other data. The coupling may be initiated by at least one controller of the vehicle and/or traffic control system upon determining that a coupling is beneficial to one or more vehicles in a group of vehicles or a traffic system. As can be appreciated, the power consumption for a group of vehicles traveling in a same direction may be reduced or decreased by removing any aerodynamic separation between vehicles. In this case, the vehicles may be coupled together to subject only the foremost vehicle in the coupling to air and/or wind resistance during travel. In one embodiment, the power output by the group of vehicles may be proportionally or selectively controlled to provide a specific output from each of the one or more of the vehicles in the group.

The interconnecting, or coupling, features may be configured, for example, as electromagnetic mechanisms, mechanical couplings, electromechanical coupling mechanisms, and/or combinations thereof. The features may be selectively deployed from a portion of the frame 104 and/or body of the vehicle 100. In some cases, the features may be built into the frame 104 and/or body of the vehicle 100. In any event, the features may deploy from an unexposed position to an exposed position or may be configured to selectively engage/disengage without requiring an exposure or deployment of the mechanism from the frame 104 and/or body of the vehicle 100. In some embodiments, the interconnecting features may be configured to interconnect one or more of power, communications, electrical energy, fuel, and/or the like. One or more of the power, mechanical, and/or communications connections between vehicles may be part of a single interconnection mechanism. In some embodiments, the interconnection mechanism may include multiple connection mechanisms. In any event, the single interconnection mechanism or the interconnection mechanism may employ the poka-yoke features as described above.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 212 of the vehicle 100. The electric motors 212 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 220 that are driven by the one or more electric motors 212 and motor controllers 214. In some cases, the vehicle 100 may include an electric motor 212 configured to provide a driving force for each drive wheel 220. In other cases, a single electric motor 212 may be configured to share an output force between two or more drive wheels 220 via one or more power transmission components. It is an aspect of the present disclosure that the powertrain may include one or more power transmission components, motor controllers 214, and/or power controllers that can provide a controlled output of power to one or more of the drive wheels 220 of the vehicle 100. The power transmission components, power controllers, or motor controllers 214 may be controlled by at least one other vehicle controller or computer system as described herein.

As provided above, the powertrain of the vehicle 100 may include one or more power sources 208A, 208B. These one or more power sources 208A, 208B may be configured to provide drive power, system and/or subsystem power, accessory power, etc. While described herein as a single power source 208 for sake of clarity, embodiments of the present disclosure are not so limited. For example, it should be appreciated that independent, different, or separate power sources 208A, 208B may provide power to various systems of the vehicle 100. For instance, a drive power source may be configured to provide the power for the one or more electric motors 212 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 208A, 208B in this manner may provide a number of benefits over conventional vehicle systems. For example, separating the power sources 208A, 208B allows one power source 208 to be removed and/or replaced independently without requiring that power be removed from all systems and/or subsystems of the vehicle 100 during a power source 208 removal/replacement. For instance, one or more of the accessories, communications, safety equipment, and/or backup power systems, etc., may be maintained even when a particular power source 208A, 208B is depleted, removed, or becomes otherwise inoperable.

In some embodiments, the drive power source may be separated into two or more cells, units, sources, and/or systems. By way of example, a vehicle 100 may include a first drive power source 208A and a second drive power source 208B. The first drive power source 208A may be operated independently from or in conjunction with the second drive power source 208B and vice versa. Continuing this example, the first drive power source 208A may be removed from a vehicle while a second drive power source 208B can be maintained in the vehicle 100 to provide drive power. This approach allows the vehicle 100 to significantly reduce weight (e.g., of the first drive power source 208A, etc.) and improve power consumption, even if only for a temporary period of time. In some cases, a vehicle 100 running low on power may automatically determine that pulling over to a rest area, emergency lane, and removing, or “dropping off,” at least one power source 208A, 208B may reduce enough weight of the vehicle 100 to allow the vehicle 100 to navigate to the closest power source replacement and/or charging area. In some embodiments, the removed, or “dropped off,” power source 208A may be collected by a collection service, vehicle mechanic, tow truck, or even another vehicle or individual.

The power source 208 may include a GPS or other geographical location system that may be configured to emit a location signal to one or more receiving entities. For instance, the signal may be broadcast or targeted to a specific receiving party. Additionally or alternatively, the power source 208 may include a unique identifier that may be used to associate the power source 208 with a particular vehicle 100 or vehicle user. This unique identifier may allow an efficient recovery of the power source 208 dropped off. In some embodiments, the unique identifier may provide information for the particular vehicle 100 or vehicle user to be billed or charged with a cost of recovery for the power source 208.

The power source 208 may include a charge controller 224 that may be configured to determine charge levels of the power source 208, control a rate at which charge is drawn from the power source 208, control a rate at which charge is added to the power source 208, and/or monitor a health of the power source 208 (e.g., one or more cells, portions, etc.). In some embodiments, the charge controller 224 or the power source 208 may include a communication interface. The communication interface can allow the charge controller 224 to report a state of the power source 208 to one or more other controllers of the vehicle 100 or even communicate with a communication device separate and/or apart from the vehicle 100. Additionally or alternatively, the communication interface may be configured to receive instructions (e.g., control instructions, charge instructions, communication instructions, etc.) from one or more other controllers or computers of the vehicle 100 or a communication device that is separate and/or apart from the vehicle 100.

The powertrain includes one or more power distribution systems configured to transmit power from the power source 208 to one or more electric motors 212 in the vehicle 100. The power distribution system may include electrical interconnections 228 in the form of cables, wires, traces, wireless power transmission systems, etc., and/or combinations thereof. It is an aspect of the present disclosure that the vehicle 100 includes one or more redundant electrical interconnections 232 of the power distribution system. The redundant electrical interconnections 232 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 232 is being used and/or damage has occurred to a particular area of the vehicle electrical system. In any event, the one or more redundant electrical interconnections 232 may be configured along completely different routes than the electrical interconnections 228 and/or include different modes of failure than the electrical interconnections 228 to, among other things, prevent a total interruption of power distribution in the event of a failure.

In some embodiments, the power distribution system may include an energy recovery system 236. This energy recovery system 236, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 236, when a vehicle 100 brakes, at least a portion of the kinetic energy is converted into electrical and/or mechanical energy for storage. Mechanical energy may be stored, for example, as mechanical movement (e.g., in a flywheel, etc.) and electrical energy may be stored, for example, in batteries, capacitors, and/or some other electrical storage system. In some embodiments, electrical energy recovered may be stored in the power source 208. For example, the recovered electrical energy may be used to charge the power source 208 of the vehicle 100.

The vehicle 100 may include one or more safety systems. Vehicle safety systems can include a variety of mechanical and/or electrical components including, but in no way limited to, low impact or energy-absorbing bumpers 216A, 216B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

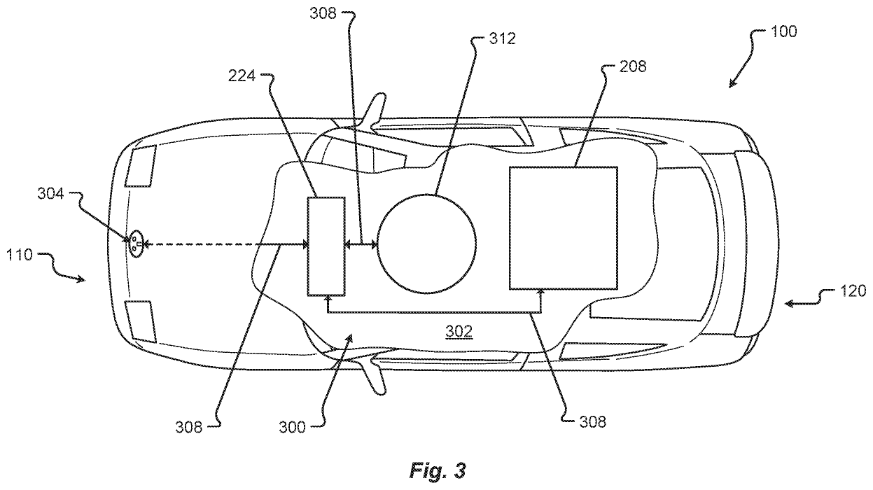

FIG. 3 shows a plan view of the vehicle 100 in accordance with embodiments of the present disclosure. In particular, FIG. 3 shows a broken section 302 of a charging system 300 for the vehicle 100. The charging system 300 may include a plug or receptacle 304 configured to receive power from an external power source (e.g., a source of power that is external to and/or separate from the vehicle 100, etc.). An example of an external power source may include the standard industrial, commercial, or residential power that is provided across power lines. Another example of an external power source may include a proprietary power system configured to provide power to the vehicle 100. In any event, power received at the plug/receptacle 304 may be transferred via at least one power transmission interconnection 308. Similar, if not identical, to the electrical interconnections 228 described above, the at least one power transmission interconnection 308 may be one or more cables, wires, traces, wireless power transmission systems, etc., and/or combinations thereof. Electrical energy in the form of charge can be transferred from the external power source to the charge controller 224. As provided above, the charge controller 224 may regulate the addition of charge to at least one power source 208 of the vehicle 100 (e.g., until the at least one power source 208 is full or at a capacity, etc.).

In some embodiments, the vehicle 100 may include an inductive charging system and inductive charger 312. The inductive charger 312 may be configured to receive electrical energy from an inductive power source external to the vehicle 100. In one embodiment, when the vehicle 100 and/or the inductive charger 312 is positioned over an inductive power source external to the vehicle 100, electrical energy can be transferred from the inductive power source to the vehicle 100. For example, the inductive charger 312 may receive the charge and transfer the charge via at least one power transmission interconnection 308 to the charge controller 324 and/or the power source 208 of the vehicle 100. The inductive charger 312 may be concealed in a portion of the vehicle 100 (e.g., at least partially protected by the frame 104, one or more body panels 108, a shroud, a shield, a protective cover, etc., and/or combinations thereof) and/or may be deployed from the vehicle 100. In some embodiments, the inductive charger 312 may be configured to receive charge only when the inductive charger 312 is deployed from the vehicle 100. In other embodiments, the inductive charger 312 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

The vehicle sensors and systems may be selected and/or configured to suit a level of operation associated with the vehicle 100. Among other things, the number of sensors used in a system may be altered to increase or decrease information available to a vehicle control system (e.g., affecting control capabilities of the vehicle 100). Additionally or alternatively, the sensors and systems may be part of one or more advanced driver assistance systems (ADAS) associated with a vehicle 100. In any event, the sensors and systems may be used to provide driving assistance at any level of operation (e.g., from fully-manual to fully-autonomous operations, etc.) as described herein.

The various levels of vehicle control and/or operation can be described as corresponding to a level of autonomy associated with a vehicle 100 for vehicle driving operations. For instance, at Level 0, or fully-manual driving operations, a driver (e.g., a human driver) may be responsible for all the driving control operations (e.g., steering, accelerating, braking, etc.) associated with the vehicle. Level 0 may be referred to as a “No Automation” level. At Level 1, the vehicle may be responsible for a limited number of the driving operations associated with the vehicle, while the driver is still responsible for most driving control operations. An example of a Level 1 vehicle may include a vehicle in which the throttle control and/or braking operations may be controlled by the vehicle (e.g., cruise control operations, etc.). Level 1 may be referred to as a “Driver Assistance” level. At Level 2, the vehicle may collect information (e.g., via one or more driving assistance systems, sensors, etc.) about an environment of the vehicle (e.g., surrounding area, roadway, traffic, ambient conditions, etc.) and use the collected information to control driving operations (e.g., steering, accelerating, braking, etc.) associated with the vehicle. In a Level 2 autonomous vehicle, the driver may be required to perform other aspects of driving operations not controlled by the vehicle. Level 2 may be referred to as a “Partial Automation” level. It should be appreciated that Levels 0-2 all involve the driver monitoring the driving operations of the vehicle.

At Level 3, the driver may be separated from controlling all the driving operations of the vehicle except when the vehicle makes a request for the operator to act or intervene in controlling one or more driving operations. In other words, the driver may be separated from controlling the vehicle unless the driver is required to take over for the vehicle. Level 3 may be referred to as a “Conditional Automation” level. At Level 4, the driver may be separated from controlling all the driving operations of the vehicle and the vehicle may control driving operations even when a user fails to respond to a request to intervene. Level 4 may be referred to as a “High Automation” level. At Level 5, the vehicle can control all the driving operations associated with the vehicle in all driving modes. The vehicle in Level 5 may continually monitor traffic, vehicular, roadway, and/or environmental conditions while driving the vehicle. In Level 5, there is no human driver interaction required in any driving mode. Accordingly, Level 5 may be referred to as a “Full Automation” level. It should be appreciated that in Levels 3-5 the vehicle, and/or one or more automated driving systems associated with the vehicle, monitors the driving operations of the vehicle and the driving environment.

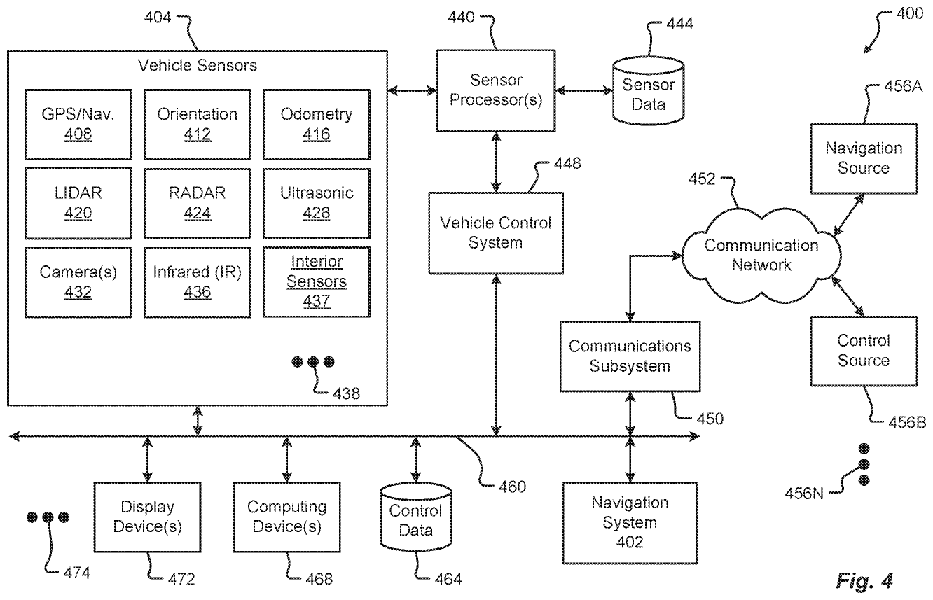

FIG. 4 is a block diagram of an embodiment of a communication environment 400 of the vehicle 100 in accordance with embodiments of the present disclosure. The communication system 400 may include one or more vehicle driving vehicle sensors and systems 404, sensor processors 440, sensor data memory 444, vehicle control system 448, communications subsystem 450, control data 464, computing devices 468, display devices 472, and other components 474 that may be associated with a vehicle 100. These associated components may be electrically and/or communicatively coupled to one another via at least one bus 460. In some embodiments, the one or more associated components may send and/or receive signals across a communication network 452 to at least one of a navigation source 456A, a control source 456B, or some other entity 456N.

In accordance with at least some embodiments of the present disclosure, the communication network 452 may comprise any type of known communication medium or collection of communication media and may use any type of protocols, such as SIP, TCP/IP, SNA, IPX, AppleTalk, and the like, to transport messages between endpoints. The communication network 452 may include wired and/or wireless communication technologies. The Internet is an example of the communication network 452 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), such as an Ethernet network, a Token-Ring network and/or the like, a Wide Area Network (WAN), a virtual network, including without limitation a virtual private network (“VPN”); the Internet, an intranet, an extranet, a cellular network, an infra-red network; a wireless network (e.g., a network operating under any of the IEEE 802.9 suite of protocols, the Bluetooth® protocol known in the art, and/or any other wireless protocol), and any other type of packet-switched or circuit-switched network known in the art and/or any combination of these and/or other networks. In addition, it can be appreciated that the communication network 452 need not be limited to any one network type, and instead may be comprised of a number of different networks and/or network types. The communication network 452 may comprise a number of different communication media such as coaxial cable, copper cable/wire, fiber-optic cable, antennas for transmitting/receiving wireless messages, and combinations thereof.

The driving vehicle sensors and systems 404 may include at least one navigation 408 (e.g., global positioning system (GPS), etc.), orientation 412, odometry 416, LIDAR 420, RADAR 424, ultrasonic 428, camera 432, infrared (IR) 436, interior 437, and/or other sensor or system 438.

The navigation sensor 408 may include one or more sensors having receivers and antennas that are configured to utilize a satellite-based navigation system including a network of navigation satellites capable of providing geolocation and time information to at least one component of the vehicle 100. Examples of the navigation sensor 408 as described herein may include, but are not limited to, at least one of Garmin® GLO™ family of GPS and GLONASS combination sensors, Garmin® GPS 15×™ family of sensors, Garmin® GPS 16×™ family of sensors with high-sensitivity receiver and antenna, Garmin® GPS 18× OEM family of high-sensitivity GPS sensors, Dewetron DEWE-VGPS series of GPS sensors, GlobalSat 1-Hz series of GPS sensors, other industry-equivalent navigation sensors and/or systems, and may perform navigational and/or geolocation functions using any known or future-developed standard and/or architecture.

The orientation sensor 412 may include one or more sensors configured to determine an orientation of the vehicle 100 relative to at least one reference point. In some embodiments, the orientation sensor 412 may include at least one pressure transducer, stress/strain gauge, accelerometer, gyroscope, and/or geomagnetic sensor. Examples of the navigation sensor 408 as described herein may include, but are not limited to, at least one of Bosch Sensortec BMX 160 series low-power absolute orientation sensors, Bosch Sensortec BMX055 9-axis sensors, Bosch Sensortec BMI055 6-axis inertial sensors, Bosch Sensortec BMI160 6-axis inertial sensors, Bosch Sensortec BMF055 9-axis inertial sensors (accelerometer, gyroscope, and magnetometer) with integrated Cortex M0+ microcontroller, Bosch Sensortec BMP280 absolute barometric pressure sensors, Infineon TLV493D-A1B6 3D magnetic sensors, Infineon TLI493D-W1 B6 3D magnetic sensors, Infineon TL family of 3D magnetic sensors, Murata Electronics SCC2000 series combined gyro sensor and accelerometer, Murata Electronics SCC1300 series combined gyro sensor and accelerometer, other industry-equivalent orientation sensors and/or systems, which may perform orientation detection and/or determination functions using any known or future-developed standard and/or architecture.

The odometry sensor and/or system 416 may include one or more components configured to determine a change in position of the vehicle 100 over time. In some embodiments, the odometry system 416 may utilize data from one or more other sensors and/or systems 404 in determining a position (e.g., distance, location, etc.) of the vehicle 100 relative to a previously measured position for the vehicle 100. Additionally or alternatively, the odometry sensors 416 may include one or more encoders, Hall speed sensors, and/or other measurement sensors/devices configured to measure a wheel speed, rotation, and/or number of revolutions made over time. Examples of the odometry sensor/system 416 as described herein may include, but are not limited to, at least one of Infineon TLE4924/26/27/28C high-performance speed sensors, Infineon TL4941plusC(B) single chip differential Hall wheel-speed sensors, Infineon TL5041plusC Giant Mangnetoresistance (GMR) effect sensors, Infineon TL family of magnetic sensors, EPC Model 25SP Accu-CoderPro™ incremental shaft encoders, EPC Model 30M compact incremental encoders with advanced magnetic sensing and signal processing technology, EPC Model 925 absolute shaft encoders, EPC Model 958 absolute shaft encoders, EPC Model MA36S/MA63S/SA36S absolute shaft encoders, Dynapar™ F18 commutating optical encoder, Dynapar™ HS35R family of phased array encoder sensors, other industry-equivalent odometry sensors and/or systems, and may perform change in position detection and/or determination functions using any known or future-developed standard and/or architecture.

The LIDAR sensor/system 420 may include one or more components configured to measure distances to targets using laser illumination. In some embodiments, the LIDAR sensor/system 420 may provide 3D imaging data of an environment around the vehicle 100. The imaging data may be processed to generate a full 360-degree view of the environment around the vehicle 100. The LIDAR sensor/system 420 may include a laser light generator configured to generate a plurality of target illumination laser beams (e.g., laser light channels). In some embodiments, this plurality of laser beams may be aimed at, or directed to, a rotating reflective surface (e.g., a mirror) and guided outwardly from the LIDAR sensor/system 420 into a measurement environment. The rotating reflective surface may be configured to continually rotate 360 degrees about an axis, such that the plurality of laser beams is directed in a full 360-degree range around the vehicle 100. A photodiode receiver of the LIDAR sensor/system 420 may detect when light from the plurality of laser beams emitted into the measurement environment returns (e.g., reflected echo) to the LIDAR sensor/system 420. The LIDAR sensor/system 420 may calculate, based on a time associated with the emission of light to the detected return of light, a distance from the vehicle 100 to the illuminated target. In some embodiments, the LIDAR sensor/system 420 may generate over 2.0 million points per second and have an effective operational range of at least 100 meters. Examples of the LIDAR sensor/system 420 as described herein may include, but are not limited to, at least one of Velodyne® LiDAR™ HDL-64E 64-channel LIDAR sensors, Velodyne® LiDAR™ HDL-32E 32-channel LIDAR sensors, Velodyne® LiDAR™ PUCK™ VLP-16 16-channel LIDAR sensors, Leica Geosystems Pegasus:Two mobile sensor platform, Garmin® LIDAR-Lite v3 measurement sensor, Quanergy M8 LiDAR sensors, Quanergy S3 solid state LiDAR sensor, LeddarTech® LeddarVU compact solid state fixed-beam LIDAR sensors, other industry-equivalent LIDAR sensors and/or systems, and may perform illuminated target and/or obstacle detection in an environment around the vehicle 100 using any known or future-developed standard and/or architecture.

The RADAR sensors 424 may include one or more radio components that are configured to detect objects/targets in an environment of the vehicle 100. In some embodiments, the RADAR sensors 424 may determine a distance, position, and/or movement vector (e.g., angle, speed, etc.) associated with a target over time. The RADAR sensors 424 may include a transmitter configured to generate and emit electromagnetic waves (e.g., radio, microwaves, etc.) and a receiver configured to detect returned electromagnetic waves. In some embodiments, the RADAR sensors 424 may include at least one processor configured to interpret the returned electromagnetic waves and determine locational properties of targets. Examples of the RADAR sensors 424 as described herein may include, but are not limited to, at least one of Infineon RASIC™ RTN7735PL transmitter and RRN7745PL/46PL receiver sensors, Autoliv ASP Vehicle RADAR sensors, Delphi L2C0051TR 77 GHz ESR Electronically Scanning Radar sensors, Fujitsu Ten Ltd. Automotive Compact 77 GHz 3D Electronic Scan Millimeter Wave Radar sensors, other industry-equivalent RADAR sensors and/or systems, and may perform radio target and/or obstacle detection in an environment around the vehicle 100 using any known or future-developed standard and/or architecture.

The ultrasonic sensors 428 may include one or more components that are configured to detect objects/targets in an environment of the vehicle 100. In some embodiments, the ultrasonic sensors 428 may determine a distance, position, and/or movement vector (e.g., angle, speed, etc.) associated with a target over time. The ultrasonic sensors 428 may include an ultrasonic transmitter and receiver, or transceiver, configured to generate and emit ultrasound waves and interpret returned echoes of those waves. In some embodiments, the ultrasonic sensors 428 may include at least one processor configured to interpret the returned ultrasonic waves and determine locational properties of targets. Examples of the ultrasonic sensors 428 as described herein may include, but are not limited to, at least one of Texas Instruments TIDA-00151 automotive ultrasonic sensor interface IC sensors, MaxBotix® MB8450 ultrasonic proximity sensor, MaxBotix® ParkSonar™-EZ ultrasonic proximity sensors, Murata Electronics MA40H1S-R open-structure ultrasonic sensors, Murata Electronics MA40S4R/S open-structure ultrasonic sensors, Murata Electronics MA58MF14-7N waterproof ultrasonic sensors, other industry-equivalent ultrasonic sensors and/or systems, and may perform ultrasonic target and/or obstacle detection in an environment around the vehicle 100 using any known or future-developed standard and/or architecture.

The camera sensors 432 may include one or more components configured to detect image information associated with an environment of the vehicle 100. In some embodiments, the camera sensors 432 may include a lens, filter, image sensor, and/or a digital image processer. It is an aspect of the present disclosure that multiple camera sensors 432 may be used together to generate stereo images providing depth measurements. Examples of the camera sensors 432 as described herein may include, but are not limited to, at least one of ON Semiconductor® MT9V024 Global Shutter VGA GS CMOS image sensors, Teledyne DALSA Falcon2 camera sensors, CMOSIS CMV50000 high-speed CMOS image sensors, other industry-equivalent camera sensors and/or systems, and may perform visual target and/or obstacle detection in an environment around the vehicle 100 using any known or future-developed standard and/or architecture.

The infrared (IR) sensors 436 may include one or more components configured to detect image information associated with an environment of the vehicle 100. The IR sensors 436 may be configured to detect targets in low-light, dark, or poorly-lit environments. The IR sensors 436 may include an IR light emitting element (e.g., IR light emitting diode (LED), etc.) and an IR photodiode. In some embodiments, the IR photodiode may be configured to detect returned IR light at or about the same wavelength to that emitted by the IR light emitting element. In some embodiments, the IR sensors 436 may include at least one processor configured to interpret the returned IR light and determine locational properties of targets. The IR sensors 436 may be configured to detect and/or measure a temperature associated with a target (e.g., an object, pedestrian, other vehicle, etc.). Examples of IR sensors 436 as described herein may include, but are not limited to, at least one of Opto Diode lead-salt IR array sensors, Opto Diode OD-850 Near-IR LED sensors, Opto Diode SA/SHA727 steady state IR emitters and IR detectors, FLIR® LS microbolometer sensors, FLIR® TacFLIR 380-HD InSb MWIR FPA and HD MWIR thermal sensors, FLIR® VOx 640×480 pixel detector sensors, Delphi IR sensors, other industry-equivalent IR sensors and/or systems, and may perform IR visual target and/or obstacle detection in an environment around the vehicle 100 using any known or future-developed standard and/or architecture.

The interior sensors 437 may include passenger compartment temperature sensors (utilized, e.g., in connection with a vehicle climate control system), passenger compartment occupancy sensors (utilized, e.g., in connection with vehicle safety systems, including passive and active restraint systems); wheel-speed sensors (utilized, e.g., in connection with an anti-lock braking system and/or an electronic traction control system); door sensors (utilized, e.g., to communicate to a vehicle operator whether the vehicle doors are locked or unlocked, and/or open or closed); light sensors (utilized, e.g., to automatically adjust the brightness of instrument panel lighting); electronic system temperature sensors (utilized, e.g., to determine whether vehicle electronic systems are within appropriate operating temperature ranges, and, in some embodiments, to enable a vehicle cooling system to route coolant to electronic systems within the vehicle that are most in need of cooling); coolant temperature sensors (utilized, e.g., to facilitate efficient vehicle thermal management); and pressure-temperature transducers (also utilized, e.g., to facilitate efficient vehicle thermal management).

A navigation system 402 can include any hardware and/or software used to navigate the vehicle either manually or autonomously.

In some embodiments, the driving vehicle sensors and systems 404 may include other sensors 438 and/or combinations of the sensors 406-437 described above. Additionally or alternatively, one or more of the sensors 406-437 described above may include one or more processors or controllers configured to process and/or interpret signals detected by the one or more sensors 406-437. In some embodiments, the processing of at least some sensor information provided by the vehicle sensors and systems 404 may be processed by at least one sensor processor 440. Raw and/or processed sensor data may be stored in a sensor data memory 444 storage medium. In some embodiments, the sensor data memory 444 may store instructions used by the sensor processor 440 for processing sensor information provided by the sensors and systems 404. In any event, the sensor data memory 444 may be a disk drive, optical storage device, solid-state storage device such as a random-access memory (“RAM”) and/or a read-only memory (“ROM”), which can be programmable, flash-updateable, and/or the like.

The vehicle control system 448 may receive processed sensor information from the sensor processor 440 and determine to control an aspect of the vehicle 100. Controlling an aspect of the vehicle 100 may include presenting information via one or more display devices 472 associated with the vehicle, sending commands to one or more computing devices 468 associated with the vehicle, and/or controlling a driving operation of the vehicle. In some embodiments, the vehicle control system 448 may correspond to one or more computing systems that control driving operations of the vehicle 100 in accordance with the Levels of driving autonomy described above. In one embodiment, the vehicle control system 448 may operate a speed of the vehicle 100 by controlling an output signal to the accelerator and/or braking system of the vehicle. In this example, the vehicle control system 448 may receive sensor data describing an environment surrounding the vehicle 100 and, based on the sensor data received, determine to adjust the acceleration, power output, and/or braking of the vehicle 100. The vehicle control system 448 may additionally control steering and/or other driving functions of the vehicle 100.

The vehicle control system 448 may communicate, in real-time, with the driving sensors and systems 404 forming a feedback loop. In particular, upon receiving sensor information describing a condition of targets in the environment surrounding the vehicle 100, the vehicle control system 448 may autonomously make changes to a driving operation of the vehicle 100. The vehicle control system 448 may then receive subsequent sensor information describing any change to the condition of the targets detected in the environment as a result of the changes made to the driving operation. This continual cycle of observation (e.g., via the sensors, etc.) and action (e.g., selected control or non-control of vehicle operations, etc.) allows the vehicle 100 to operate autonomously in the environment.

In some embodiments, the one or more components of the vehicle 100 (e.g., the driving vehicle sensors 404, vehicle control system 448, display devices 472, etc.) may communicate across the communication network 452 to one or more entities 456A-N via a communications subsystem 450 of the vehicle 100. For instance, the navigation sensors 408 may receive global positioning, location, and/or navigational information from a navigation source 456A. In some embodiments, the navigation source 456A may be a global navigation satellite system (GNSS) similar, if not identical, to NAVSTAR GPS, GLONASS, EU Galileo, and/or the BeiDou Navigation Satellite System (BDS) to name a few.

In some embodiments, the vehicle control system 448 may receive control information from one or more control sources 456B. The control source 456 may provide vehicle control information including autonomous driving control commands, vehicle operation override control commands, and the like. The control source 456 may correspond to an autonomous vehicle control system, a traffic control system, an administrative control entity, and/or some other controlling server. It is an aspect of the present disclosure that the vehicle control system 448 and/or other components of the vehicle 100 may exchange communications with the control source 456 across the communication network 452 and via the communications subsystem 450.

Information associated with controlling driving operations of the vehicle 100 may be stored in a control data memory 464 storage medium. The control data memory 464 may store instructions used by the vehicle control system 448 for controlling driving operations of the vehicle 100, historical control information, autonomous driving control rules, and the like. In some embodiments, the control data memory 464 may be a disk drive, optical storage device, solid-state storage device such as a random-access memory (“RAM”) and/or a read-only memory (“ROM”), which can be programmable, flash-updateable, and/or the like.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

For an autonomous, semi-autonomous, or manually operated electric vehicle 100 as described above, thermal management is critical. For example, the batteries or other power source, inverters, drive motors, and other electrical components need to be sufficiently cooled. Failure to provide sufficient cooling to these components can result in damage or even catastrophic failure of the components. Autonomous vehicles in particular must prove to be resilient to avoid such failures and continue to operate in a safe manner until the vehicle can be driven to a repair location or at least removed from a roadway to a shoulder or parking area.

Turning now to FIG. 5, a thermal management system 500 of a vehicle 100 according to embodiments of the present disclosure comprises two coolant loops and one refrigerant loop. At least one of the coolant loops and the refrigerant loop are connected via a chiller 568, and the two coolant loops are connected via a four-way valve 5200. More specifically, each of the two coolant loops circulates fluid through the four-way valve 5200. As disclosed, the thermal management system 500 is configured to manage battery cooling, cabin cooling, wireless charger cooling, electric motor cooling, on-board charger cooling, and on-board electronics (including self-driving computer) cooling. The thermal management system 500 has several unique operational modes, including but not limited to: a normal mode; a two-stage cooling mode; a failure mode (in which the four-way valve 5200 is configured in a cross-over mode, allowing both coolant loops to be linked and driven by a single pump 536, 572 if one of the pumps 536, 572 fails); a heat pump mode that uses an inside condenser 544 to provide heated air in the cabin; and a heat harvest mode that uses heat from the electronics 520 to heat the battery 584. Moreover, the thermal management system 500 is optimized via valves and sensors to increase battery usage efficiency. These and other aspects of the thermal management system 500 are described in greater detail below.

The four-way valve 5200, in a first, non-crossover configuration, routes coolant received at port 5204 to port 5202, and coolant received at port 5201 to port 5203, thus maintaining two separate coolant loops. Coolant exiting port 5202 travels into a T-joint 5601, where some of the coolant may be selectively routed through a ball valve 504 to a front motor/inverter 508 (by selectively opening or closing the ball valve 504), and the remainder of the coolant is routed into a T-joint 5602. From the T-joint 5602, some of the coolant may be selectively routed through another ball valve 512 to a rear motor/inverter 516 (by selectively opening or closing the ball valve 512), and the remainder of the coolant is routed to the vehicle electronics 520, then through a T-joint 5603 to on-board chargers 524, 528. From the on-board chargers 524, 528, the coolant is recombined at a T-joint 5604, and then travels to a T-joint 5605 where the coolant is recombined with coolant exiting the rear motor/inverter 516. Yet another T-joint 5606 receives the coolant from the T-joint 5605 as well as coolant exiting the front motor/inverter 508.

While the various flow paths described above and elsewhere herein represent one embodiment of the present disclosure, other flow paths may be defined in accordance with other embodiments of the present disclosure. For example, in some embodiments, the on-board chargers 524, 528 may be located on a separate flow path than the vehicle electronics 520. Similarly, in some embodiments the one or more valves may be used to selectively open and close a flow path including the vehicle electronics 520 and/or the on-board chargers 524, 528, whether instead of or in addition to the ball valves 504 and 512 used to selectively route coolant to the front motor/inverter 508 and the rear motor/inverter 516. Further still, connectors other than T-joints may be used to combine two separate flow paths or divide a single flow path into two separate flow paths.

Returning to the description of FIG. 5, all of the coolant that entered the various flow paths described above, beginning at the T-joint 5601, is recombined upon reaching the T-joint 5606. The temperature of the recombined coolant is sensed by a coolant temperature sensor 5702 as the recombined coolant is routed to a port 5501 of a three-way valve 5500. If the sensed temperature of the recombined coolant is higher than desired, the three-way valve 5500 is configured to route the coolant through port 5502 to a low-temperature radiator 532, after which the coolant temperature is again sensed by a coolant temperature sensor 5701. If the temperature of the recombined coolant as sensed by the coolant temperature sensor 5702 is acceptable, then the three-way valve 5500 is configured to route the coolant through the port 5503. The T-joint 5607 receives coolant exiting the low-temperature radiator 532 and the coolant temperature sensor 5701 (when the coolant is routed through the port 5502 of the valve 5500), or alternatively receives coolant exiting the port 5503 of the valve 5500, and routes the received coolant to a pump 536, which pumps the coolant into the port 5204 of the valve 5200.

As may be appreciated from the foregoing description, coolant in the coolant loop described above may be selectively routed to the front motor/inverter 508 and the rear motor/inverter 516 by selectively opening and closing the ball valves 504 and 512, respectively. Thus, if the temperature of the front and/or rear motor/inverters 508 and 516 is undesirably high, the corresponding ball valves 504 and/or 512 may be opened, and coolant may be routed to the front and/or rear motor/inverters 508 and 516 for cooling purposes. Alternatively, if the front motor/inverter 508 and the rear motor/inverter 516 are sufficiently cool, then the ball valves 504 and 512 may be closed, such that all of the coolant in the described coolant loop is routed to the vehicle electronics 520 and the on-board chargers 524, 528. Moreover, if the coolant absorbs enough heat from the front motor/inverter 508, the rear motor/inverter 516, the vehicle electronics 520, and/or the on-board chargers 524, 528 to necessitate cooling, then the valve 5500 may be selectively configured to route the hot coolant to the low-temperature radiator 532. Alternatively, if the coolant received at the valve 5500 does not need to be cooled (or if the coolant received at the valve 5500 is purposefully being warmed), then the valve 5500 may be selectively configured to cause the coolant to bypass the low-temperature radiator. The ability to selectively route coolant to the various components of the coolant loop—including those components that transfer heat to the coolant and those components that extract heat from the coolant—enables the thermal management system 500 to be operated in the most efficient manner possible.

Turning now to the second coolant loop, coolant exiting port 5203 of the four-way valve 5200 is routed directly into a port 5101 of a three-way valve 5100. The three-way valve 5100 may be selectively configured to route the coolant out of a port 5103 and through a T-joint 5616 to the vehicle battery 584, after which the coolant is returned to the four-way valve 5200 via the port 5201. Alternatively, the three-way valve 5100 may be selectively configured to route the coolant through a port 5102 and a T-joint 5608 and into another three-way valve 5400 via a port 5401. The three-way valve 5400 may be selectively configured to route coolant directly to a T-joint 5612 via a port 5402. Alternatively, if the wireless charger 580 needs to be cooled, then the three-way valve 5400 may be selectively configured to route coolant to the T-joint 5612 via a port 5403 and a wireless charger 580.

Once the coolant reaches the T-joint 5612, the coolant is routed to the pump 572, which pumps the coolant to the chiller 568 via the coolant temperature sensor 5704. When refrigerant is routed through the chiller 568 from the refrigerant loop, the chiller 568 uses the refrigerant to extract heat from, and thus to cool, the coolant. A coolant temperature sensor 5703 senses the temperature of the coolant exiting the chiller 568. From the coolant temperature sensor 5703, the coolant is routed to the high voltage heater 576, which may be selectively activated to heat the coolant (e.g., if the coolant is being used to heat, rather than to cool, one or more vehicle components such as the battery, or to heat cabin air via the heater core 540). As persons of ordinary skill in the art will realize based on this disclosure, if the thermal management system 500 is using the chiller 568 to cool coolant, then the thermal management system 500 will not also use the high voltage heater 576 to then heat the same coolant, which would be an unnecessary waste of energy. Likewise, if the high voltage heater 576 is being used to heat coolant, then the thermal management system 500 will not also use the chiller 568 to cool the coolant.

From the high voltage heater 576, coolant enters the valve 5300 via the port 5301. The valve 5300 may be selectively configured to route the coolant to the battery via a port 5302 and the T-joint 5616, and from the battery back to the port 5201 of the four-way valve 5200. Alternatively, the valve 5300 may be selectively configured to route the coolant, via a port 5303, to the heater core 540, where the coolant is used to heat air for vehicle cabin climate control purposes. (The heater core 540 is part of the HVAC (heating, ventilation, and air-conditioning) module 588 of the vehicle 100, which also comprises an inside condenser 544 and an evaporator 548 and is useful for conditioning air that will be introduced in the passenger cabin of the vehicle 100. These latter two components are discussed in greater detail below.) From the heater core 540, the coolant returns to the T-joint 5608, from which the coolant is routed to the valve 5400, the operation of which is described above.

Like the first coolant loop, the second coolant loop comprises a variety of available flow paths, which allow the thermal management system 500 to efficiently manage thermal energy. For example, the valve 5100 may be used to route coolant directly to the battery 584 and then back to the four-way valve 5200, or alternatively to route coolant to the remainder of the second coolant loop. Similarly, the valve 5400 may be used to selectively route coolant to the wireless charger 580 (if the wireless charger 580 needs to be cooled), or to selectively route coolant past the wireless charger 580 (if the wireless charger 580 does not need to be cooled). Both the chiller 568 and the high voltage heater 576 may be selectively used to control the temperature of the coolant within the second coolant loop.

Turning now to the refrigerant loop of the thermal management system 500, an electric compressor 556 compresses refrigerant in the loop, which is then routed through a pressure-temperature transducer 5802 and into a T-joint 5613. In embodiments of the present disclosure used for other than electric vehicles, a gas-powered compressor or other non-electric compressor may be used in place of the electric compressor 556. If the solenoid valve 5901 is closed and the electronic expansion valve 5910 is open, then refrigerant entering the T-joint 5613 is routed through the inside condenser 544, where the refrigerant is used to condition air (by heating the air) for vehicle cabin climate control purposes. If the solenoid valve 5901 is open and the electronic expansion valve 5910 is closed, the refrigerant bypasses the inside condenser 544. Whether refrigerant passes through the inside condenser 544 or the solenoid valve 5901, the refrigerant is received at the T-joint 5609, from which it is routed to the outside condenser 560. The outside condenser 560 allows the refrigerant to exchange heat with the outside atmosphere. The outside condenser 560 may comprise a fan (as shown) to increase the rate of flow of air over the outside condenser, and thus increase the rate of heat transfer from the refrigerant to the atmosphere.

Once the refrigerant passes through the outside condenser 560, it passes through another pressure-temperature transducer 5805 and into a T-joint 5610. If the solenoid valve 5903 is open, then the refrigerant is routed to a T-joint 5615 and then into the accumulator 552. The accumulator 552 serves as a reservoir for the refrigerant and ensures that the refrigerant enters the compressor 556 at an acceptable rate, thus avoiding damage to the compressor 556. A pressure-temperature transducer positioned between the accumulator 552 and the compressor 556 determines the pressure and temperature of the refrigerant entering the compressor 556.

If the solenoid valve 5903 is closed, then refrigerant entering the T-joint 5610 is routed into the reheater/dehydrator 564. The reheater/dehydrator 564 contains excess refrigerant when the entire volume of refrigerant within the refrigerant loop does not need to be circulated, and also contains a desiccant pack to absorb moisture from the refrigerant.

Refrigerant exiting the reheater/dehydrator 564 may be selectively routed (by opening the solenoid valve 5902 and closing the solenoid valve 5904) through the electronic expansion valve 5912 (which expands and cools the refrigerant) and into the evaporator 548, where the refrigerant is used to cool air for vehicle cabin climate control purposes. A pressure-temperature transducer 5803 determines the pressure and temperature of refrigerant exiting the evaporator 548, which is then routed to the accumulator through T-joints 5614 and 5615.

Alternatively, refrigerant exiting the reheater/dehydrator 564 may be selectively routed (by closing the solenoid valve 5902 and opening the solenoid valve 5904) through the electronic expansion valve 5914 (which expands and cools the refrigerant) and into the chiller 568, where the refrigerant is used to extract heat from coolant also being routed through the chiller 568. A pressure-temperature transducer 5804 determines the pressure and temperature of refrigerant exiting the chiller 568, which is then routed to the accumulator through T-joints 5614 and 5615.

Like the two coolant loops of the thermal management system 500, then, the refrigerant loop includes multiple available flow paths for enabling efficient management of thermal energy. The inclusion of an inside condenser enables air that will be used for climate control purposes within the vehicle cabin to be heated either with coolant (using the heater core 540) or with refrigerant (using the inside condenser 544), depending on which allows for the most efficient heating in a given operating environment. When the inside condenser 544 is not being used, the refrigerant can be routed around the inside condenser 544 via the solenoid valve 5901.

Additionally, refrigerant exiting the outside condenser 560 may be routed back to the accumulator 552, or through the reheater/dehydrator 564 and into the evaporator 548 for cooling cabin air, or through the reheater/dehydrator 564 and into the chiller 568 for extracting heat from coolant. With these various available flow paths, the most efficient and desirable flow path for a given thermal management scenario may be utilized, thus conserving limited on-board energy and avoiding the unnecessary use (and corresponding wear and tear) of thermal management system components.

As noted above, the thermal management system 500 is capable of use in several modes of operation, including a (1) normal mode; (2) two-stage cooling mode; (3) heat pump mode; (4) heat harvest mode; and (5) failure mode.

In the normal mode of operation, the first coolant loop (meaning the loop that includes the T-joints 5601 and 5607, and the pump 536) is used to cool the front motor/inverter 508, the rear motor/inverter 516, the vehicle electronics 520, and the on-board chargers 524, 528. Heat absorbed by the coolant from these components is extracted from the coolant as it passes through the low-temperature radiator 532. In the second coolant loop, the valve 5100 is configured to route coolant from the port 5101 to the port 5102; the coolant is used to cool the wireless charger 580 and the battery 584; the chiller 568 is used to remove heat from the coolant; the high voltage heater 576 is switched off; and the valve 5300 routes coolant from the port 5301 to the port 5302 (thus bypassing the heater core 540). In the refrigerant loop, the solenoid valve 5901 is opened and the electronic expansion valve 5910 is closed, thus bypassing the inside condenser; the solenoid valve 5903 is closed; refrigerant is routed through the opened solenoid valve 5902 into the evaporator 548 for cooling vehicle cabin air; and the solenoid valve 5904 is selectively opened to provide refrigerant to the chiller 568 as necessary for extracting heat from the coolant in the second coolant loop.

In the two-stage cooling mode of operation, the valve 5200 is placed in a second, cross-over configuration, with incoming coolant at the port 5204 routed to the outlet port 5203, and incoming coolant at the port 5200 routed to the outlet port 5202. In the first coolant loop, the valve 5500 is configured to route coolant from the port 5501 to the port 5502. In the second coolant loop, the valve 5100 is configured to route coolant from the port 5101 to the port 5102; the valve 5300 is configured to route coolant from the port 5301 to the port 5302; and the valve 5400 is configured to route coolant from the port 5401 to the port 5402. With this configuration, coolant is pre-cooled at the low-temperature radiator 532, then routed through the pump 536, the valve 5200, the valve 5100, the valve 5400, and the pump 572 into the chiller 568 for further cooling. Thus, in the two-stage mode of operation, the radiator 532 serves as the first cooling stage, and the chiller 568 serves as the second cooling stage. By using the low-temperature radiator 532 (which does not use any on-board energy to cool the coolant) for pre-cooling, the dual-stage cooling mode of operation reduces the cooling burden on the chiller 568, and thus reduces the amount of energy used to extract heat from the coolant.

In the heat pump mode of operation, the solenoid valve 5903 is opened (thus bypassing the flow paths through the evaporator 548 and the chiller 568), and the solenoid valves 5901, 5902, and 5904 are closed. In this mode, refrigerant is compressed (and thus heated) by the compressor 556, then releases heat through the inside condenser 544 and the outside condenser 560 before returning to the compressor 556 via the accumulator 552.

In the heat harvest mode of operation, used to warm a cold battery, coolant absorbs heat from the front motor/inverter 508, the rear motor/inverter 516, the vehicle electronics 520, and/or the on-board charters 524 and 528. At the valve 550, the hot coolant is routed from the port 5501 to the port 5503, thus bypassing the low-temperature radiator 532. The valve 5200 is configured for crossover flow, so as to route the hot coolant from the port 5204 to the port 5200. The valve 5100 receives the hot coolant at the port 5101 and routes the hot coolant to the port 5103, so that the coolant bypasses the majority of the second coolant loop and arrives at the cold battery 584 via the T-joint 5616. After transferring heat to the battery 584, the coolant returns to the valve 5200, where the coolant is routed from the port 5201 to the port 5202 and thus back into the first coolant loop. The coolant is then again heated by the heat-producing components of the first coolant loop, allowing the heat harvesting process to continue. Although the battery 584 could also be warmed by coolant that has been heated in the second coolant loop by the high voltage heater 576, the ability of the thermal management system 500 to harvest excess heat from heat-producing vehicle components, rather than expending additional energy to generate heat, allows for more efficient management of thermal energy within the vehicle, and better conservation of on-board energy.

The failure mode of operation is useful when one of the two pumps 536, 572 of the thermal management system 500 fails or otherwise ceases to function properly. In this mode, the valve 5200 is again configured for crossover flow, with incoming coolant at the port 5204 routed to the port 5203, and incoming coolant at the port 5201 routed to the port 5202. In this configuration, the first and second coolant loops are connected in series rather than operating in parallel, and the functioning one of the pumps 536, 572 provides sufficient pressure to serve all critical components and still maintain adequate performance to bring the vehicle to a safe state. As with other modes of operation, the valves 5100, 5300, 5400, and 5500 may be opened or closed as appropriate to ensure that heat-producing components are properly cooled and/or that undesirably cold components are heated, while also ensuring that the coolant temperature is properly regulated.

In some embodiments, the failure mode of operation may be utilized to conserve energy by running only one of the pumps 536, 572. Because each pump inherently has an efficiency curve, such that running each pump at the speed/RPM that yields the highest energy efficiency enables more efficient operation of the thermal management system 500, there may be instances where, instead of running both pumps 536, 572 at inefficient speeds, the same or nearly the same performance may be obtained by running only one of the pumps 536, 572 at or near the point of peak efficiency. In such instances, reconfiguring the valve 5200 to connect the first and second coolant loops in series enables both loops to be serviced by the single, efficiently operating pump 536 or 572.

Beyond conserving on-board energy, the use of a thermal management system 500 to enhance thermal management efficiency also beneficially reduces the amount of time that the pumps 536, 572, the compressor 556, and other noise-producing components of the thermal management system 500 must be run. This reduction in operating time beneficially reduces the amount of noise produced by the thermal management system 500, thus yielding an improved experience for vehicle occupants and reduced noise pollution in the environments in which vehicles having the thermal management system 500 operate.

Any of the solenoid valves described herein may be replaced with any other electrically operated valve suitable for use in refrigerant lines. Similarly, the T-joints described herein may be any connector for connecting (and maintain fluid communication between) two input refrigerant lines and a single output refrigerant line, or a single input refrigerant line and two output refrigerant lines. Additionally, expansion valves other than electronic expansion valves may be used instead of the electronic expansion valves described herein. The pressure-temperature transducers described herein may be replaced with individual pressure and temperature transducers, or with any other device suitable for measuring or otherwise detecting refrigerant pressure and/or refrigerant temperature. Likewise, the coolant temperature sensors described herein may be any device suitable for measuring or otherwise detecting the temperature of coolant.

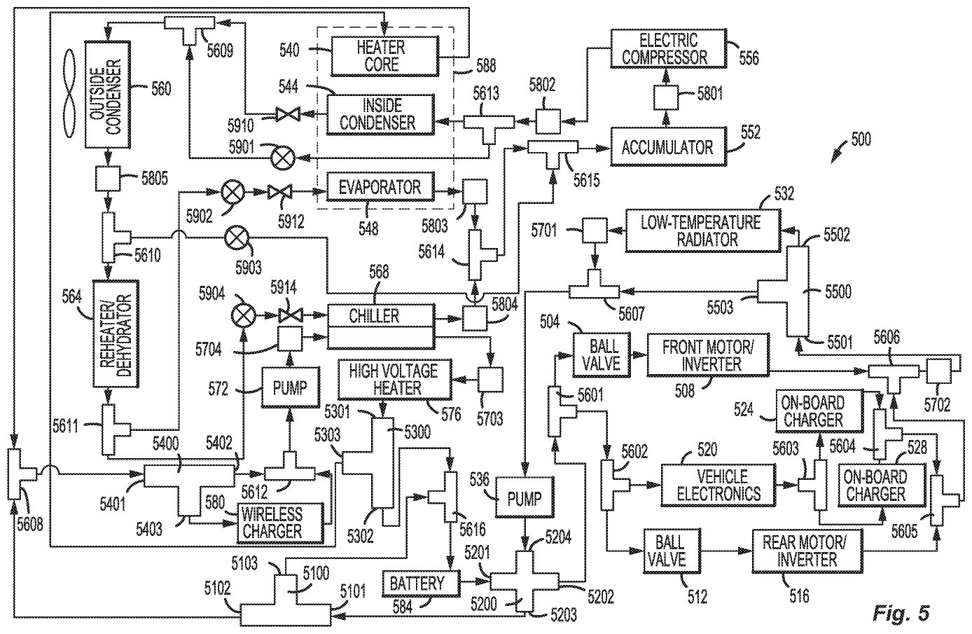

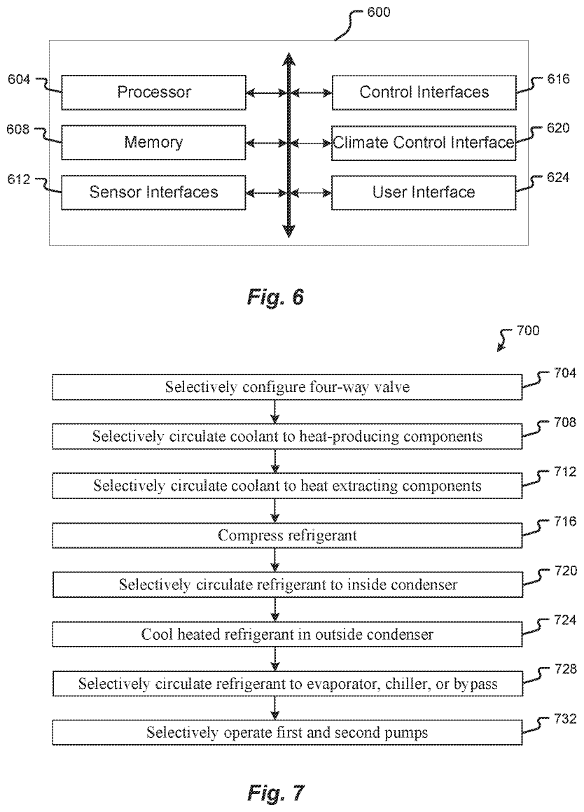

Turning now to FIG. 6, the thermal management system 500 may be controlled by a control device 600, which may comprise, for example, a processor 604; a memory or other computer-readable storage medium 608; one or more sensor interfaces 612; one or more control interfaces 616; a climate control interface 620; and a user interface 624.

The processor 604 may correspond to one or multiple microprocessors, and may be a dedicated processor for controlling the thermal management system 500 or a processor that fulfills one or more additional functions within the vehicle 100. The processor 604 may comprise a Central Processing Unit (CPU) on a single Integrated Circuit (IC) or a plurality of IC chips. The processor 604 may be a multipurpose, programmable device that accepts digital data as input, processes the digital data according to instructions stored in its internal memory, and provides results as output. The processor 604 may implement sequential digital logic, as it has internal memory. As with most known microprocessors, the processor 604 may operate on numbers and symbols represented in the binary numeral system. The processor 604 may also be configured to execute instructions stored in the memory 608, to receive data via the sensor interfaces 612, the control interfaces 616, the climate control interface 620, and/or the user interface 624, and to transmit control or other signals via the sensor interfaces 612, the control interfaces 616, the climate control interface 620, and/or the user interface 624.

The memory 608 may be used to store any electronic data needed for operation and control of the thermal management system 500 and/or any electronic data received via the sensor interfaces 612, the control interfaces 616, the climate control interface 620, and/or the user interface 624. The memory 608 may store firmware needed to enable the processor 604 to operate and/or communicate with the various components of the control device 600 and/or of the thermal management system 500, as needed. The memory 608 may also store drivers for operating one or more of the components of the control device 600 and/or of the thermal management system 500. The memory 608 may correspond to any type of non-transitory computer-readable medium. In some embodiments, the memory 608 may comprise volatile or non-volatile memory and a controller for the same. Non-limiting examples of memory 608 that may be utilized in the control device 600 include RAM, ROM, buffer memory, flash memory, solid-state memory, and variants thereof.

The sensor interfaces 612 enable the processor 604 to receive data from the plurality of sensors in the thermal management system 500, including the coolant temperature sensors 5701, 5702, 5703, 5704 and the pressure-temperature transducers 5801, 5802, 5803, 5804, and 5805. In some embodiments, the sensor interfaces 612 may also enable the processor 604 to transmit one or more control signals or other signals to one or more sensors within the thermal management system 500. The sensor interfaces 612 may also enable the processor 604 to receive data from sensors not shown in FIG. 5, such as temperature sensors on heat-producing or other temperature-sensitive components; flow sensors in one or more of the lines through which coolant and/or refrigerant is routed between components of the thermal management system 500; and any other sensors providing information that may be useable by the processor 604 for controlling the thermal management system 500.

The control interfaces 616 enable the processor 604 to transmit control signals to the plurality of controllable components of the thermal management system 500, including the ball valves 504 and 512; the four-way valve 5200; the three-way valves 5100, 5300, 5400, and 5500; the solenoid valves 5901, 5902, 5903, and 5904; the electronic expansion valves 5910, 5912, and 5914; the pumps 536 and 572; and the high voltage heater 576. The control signals may, for example, cause a given component to turn on or off; to switch from one configuration to another; to operate at a certain setting or level; and/or to open (whether fully or partially) or close (whether fully or partially). In some embodiments, the control interfaces 616 may be configured to convert a control signal generated by the processor 604 from one format into a different format understandable by the recipient component. Also in some embodiments, the control interfaces 616 may be configured to receive acknowledgment signals and/or other feedback signals from the one or more components of the thermal management system 500 that are connected to the control device 600 via the control interfaces 616, and to pass such signals to the processor 604. In such embodiments, the control interfaces 616 may be configured to convert the acknowledgement signals and/or other feedback signals from a format in which the signals are received into a different format understandable by the processor 604.

The climate control interface 620 allows the processor 604 to receive signals, which may comprise information and/or instructions, from a climate control system of the vehicle 100. Such information and/or instructions may, for example, be used by the processor 604 to determine whether to route coolant through the heater core 540, whether to route refrigerant through the inside condenser 544, and/or to determine whether to route refrigerant through the evaporator 548.

The user interface 624 may be used to display information about the thermal state of the vehicle 100 and/or of one or more components of the vehicle 100 to a user of the vehicle 100. For example, the user interface 624 may be used to provide information to a user (whether in textual, graphical, or audible form) about the operation of the thermal management system 500, including the current configuration of the valves 5100, 5200, 5300, 5400, and 5500; the current status of the pumps 536, 572; the current configuration of the solenoid valves 5901, 5902, 5903, and 5904; the current status of the electronic expansion valves 5910, 5912, and 5914; the current status of the ball valves 504, 512; the current flow path of coolant through the coolant loops and of refrigerant through the refrigerant loop; the current temperature and pressure readings reported by the coolant temperature sensors 5701, 5702, 5703, and 5704, and by the pressure-temperature transducers 5801, 5802, 5803, 5804, and 5805; and other such information. In some embodiments, the user interface 624 may be configured to receive user input relevant to the operation of the thermal management system 500. Such input may include, for example, a desired flow path of coolant and/or refrigerant within the thermal management system 500; a selection of one of the inside condenser 544 and the heater core 540 for heating cabin air; a selection of an operational mode of the thermal management system 500; and/or an indication of which components of the vehicle 100 should be given the highest priority for heating and/or cooling (e.g., the battery 584, the front motor/inverter 508, the rear motor/inverter 516, the on-board chargers 524, 528, the vehicle electronics 520, the wireless charger 580).

Using information received via the sensor interfaces 612, the control interfaces 616, the climate control interface 620, and/or the user interface 624, and upon the execution of instructions stored in the memory 608, the processor 604 determines how to configure the thermal management system 500 to ensure that all components connected thereto remain within acceptable temperature limits (which limits may be stored, for example, in the memory 608) and that the system 500 is operated efficiently.

Turning now to FIG. 7, a method 700 of managing a thermal management system such as the thermal management system 500 comprises selectively configuring, or causing to be configured, a four-way valve, to either maintain two separate coolant loops or, alternatively, to connect two coolant loops in series to form a single coolant loop (step 704). Maintaining two separate coolant loops may be preferable, for example, when each coolant loop has a functioning pump for circulating coolant therethrough, and when the heating and cooling needs of the components in each coolant loop can be efficiently met by the separate loops. For this to be possible, each loop must have at least one heat-generating or heat-producing component (e.g., a motor, an inverter, a charger, vehicle electronics, a battery, a wireless charger, a high voltage heater, a heater core) as well as at least one heat-extracting component (e.g., a radiator, a battery, a chiller).

The method 700 also comprises selectively circulating, or causing to be circulated, coolant to heat-producing components (step 708). One or more of the heat-producing components identified above may be provided in each coolant loop, and coolant may be selectively circulated to the one or more heat-producing components by opening and closing one or more valves as necessary to open a flow path that will circulate coolant to the heat-producing component(s) as desired.

The method 700 also comprises selectively circulating, or causing to be circulated, coolant to heat-extracting components (step 712). One or more of the heat-extracting components identified above may be provided in each coolant loop, and coolant may be selectively circulated to the one or more heat-extracting components by opening and closing one or more valves as necessary to open a flow path that will circulate coolant to the heat-extracting component(s) as desired.

Where the four-way valve has been configured to combine the two coolant loops into a single coolant loop, all of the heat-producing components to which coolant is circulated may be located in the first of the two joined coolant loops, and the heat-extracting component(s) may be located in the second of the two joined coolant loops.

The method 700 also comprises compressing, or causing to be compressed, refrigerant using a compressor (step 716). Pressurizing the refrigerant adds heat to the refrigerant, and thus yields heated refrigerant that can be circulated through one or more heat-extracting components. In some embodiments, an electric compressor may be used to compress the refrigerant, which refrigerant may be provided to the electric compressor from an accumulator. The accumulator may be configured, for example, to ensure a constant, uninterrupted flow of refrigerant to the compressor.

The method 700 also comprises selectively circulating, or causing to be circulated, the heated refrigerant to an inside condenser (step 720). The inside condenser may, in some embodiments, form part of an HVAC module, and may be used to heat air that will be used for climate control within an enclosed volume. Moreover, an expansion valve may be positioned immediately after the inside condenser, to expand and further cool refrigerant that has passed through the inside condenser. If the heated refrigerant is not circulated through the inside condenser, then the heated refrigerant may be circulated through a bypass line around the inside condenser. One or more valves, such as a solenoid valve, may be used to achieve the desired coolant circulation path.

The method 700 also comprises cooling, or causing to be cooled, the heated refrigerant in an outside condenser (step 724). Unlike the inside condenser, the outside condenser is exposed to the outside atmosphere, and therefore facilitates the transfer of heat from the heated refrigerant to the outside atmosphere. If the heated refrigerant has already passed through the inside condenser (and, in some embodiments, through an expansion valve positioned after the inside condenser), then the outside condenser further cools the heated refrigerant. If the heated refrigerant was routed around the inside condenser, then the outside condenser provides initial cooling to the heated refrigerant.

The method 700 also comprises selectively circulating, or causing to be circulated, refrigerant to an evaporator, a chiller, or through a bypass line around the evaporator and the chiller. The evaporator also forms part of an HVAC system, and facilitates the transfer of heat to the refrigerant from air to be used to cool an enclosed volume such as a vehicle passenger cabin. In some embodiments, the refrigerant is passed through an expansion valve prior to entering the evaporator, to further expand and cool the refrigerant and increase the capacity of the refrigerant to extract heat from the air surrounding the evaporator.

The chiller extracts heat from coolant used in one or both of the coolant loops, and may be particularly useful, for example, when the battery or other heat-producing components being cooled by the coolant are particularly hot or otherwise in need of greater cooling. The chiller may be used to cool heated coolant, or to further cool coolant that has already been passed through and cooled by a radiator. Refrigerant circulated through the chiller may first be passed through an expansion valve to further expand and cool the coolant, thus increasing the capacity of the refrigerant to extract heat from coolant in the chiller.

The bypass line around the evaporator and chiller may be used when neither the evaporator nor the chiller is needed for the thermal management system to effectively manage thermal energy. In some circumstances, for example, it may be desirable to circulate heated refrigerant to the inside condenser, and then return it to the compressor as directly as possible for recirculation to the inside condenser. In such circumstances, the bypass line around the evaporator and the chiller may be utilized.

The method 700 may also comprise selectively operating, or causing to be operated, first and second pumps to circulate coolant within the first and second coolant loops or the single, combined coolant loop (step 700). For example, in some circumstances the heat-producing components in one or both of the first and second coolant loops may be inactive, not producing heat, or otherwise not in need of cooling. In such circumstances, the pump in each such loop may be turned off, to avoid using energy unnecessarily (and, in some embodiments, to avoid unnecessary noise pollution and/or vibration). Additionally, when the four-way valve is configured to create a single, combined coolant loop, one of the first and second pumps may be turned off, so as to allow the other of the first and second pumps to maintain circulation of coolant within the single, combined loop without unnecessarily expending energy to keep both pumps running (and, again, in some embodiments, to avoid unnecessary noise pollution and/or vibration).

The steps of the method 700 need not be performed in the order shown in FIG. 7 and described above. In some embodiments, the method 700 may comprise fewer than all of the steps shown in FIG. 7 and described above. In other embodiments, the method 700 may comprise additional steps beyond those shown in FIG. 7 and described above. Such steps may include, for example, any steps necessary or useful to operate a thermal management system 500 (including a control device 600) as disclosed herein.

The steps of the method 700 may be performed, for example, by a processor executing instructions stored in a memory, which instructions cause the processor to send command signals to one or more electrically operated switches, valves, pumps, compressors, and/or other components to carry out the method steps. Additionally or alternatively, one or more of the steps of the method 700 may be accomplished manually, e.g., by a human operator manually adjusting the four-way valve between the first configuration and the second configuration, and/or manually opening or closing one or more valves or other flow control devices to cause coolant to be circulated along a desired flow path, and/or to manually turn on or off the compressor, the first pump, and/or the second pump.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be any conduit suitable for transmission of the medium in question. For example, pipes, tubes, hoses, and other fluid conduits may be used for circulating coolant and/or refrigerant between and among the components of the coolant and refrigerant loops, respectively, described herein. Additionally, wired or wireless links, or any combination thereof, or any other known or later developed element(s) that is capable of supplying and/or communicating data, may be used for carrying electrical signals to and from electronic elements described herein. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowchart of FIG. 7 has been discussed and illustrated in relation to a particular sequence of events, it should be appreciated that changes, additions, and omissions to this sequence can occur without materially affecting the operation of the disclosed embodiments, configuration, and aspects.

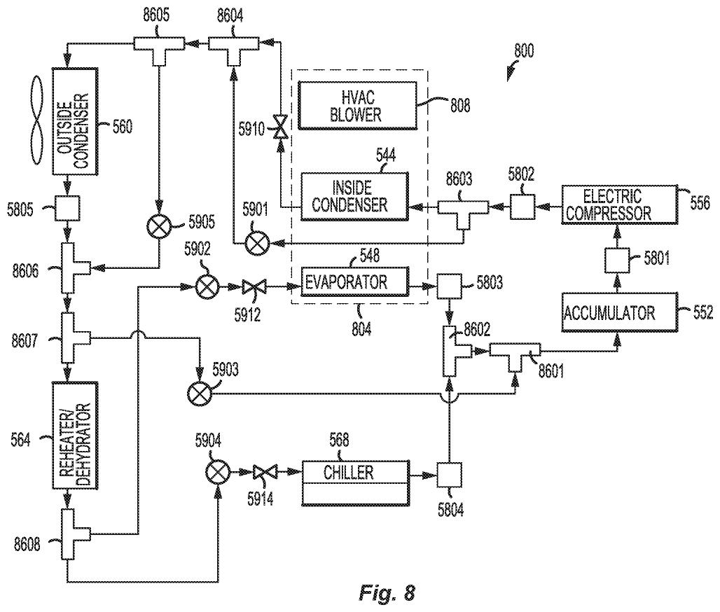

With respect to FIG. 8, thermal management system topologies using an inside condenser, such as an air-to-air heat pump, tend to use the inside condenser in addition to the “traditional” outside condenser to allow for the refrigerant loop to be operated in a so-called heat-pump mode. In such topologies, each condenser is sized to fill the specified function of each mode (heating and cooling) individually. The result is a system that is designed to operate statically in traditional modes, instead of overlapping functionalities to optimize the total system.

Instead of using independently sized outside and inside condensers for each of the heating and cooling modes of a heat pump, the inside condenser and the outside condenser can be sized for simultaneous use, such that both may be used to optimize synergies in the function of the two condensers and minimize both total system cost and total system mass (which, when the thermal management system is installed in a vehicle, yields a corresponding decrease in the amount of energy required to move the vehicle).

FIG. 8 illustrates a refrigerant loop 800 of a thermal management system, such as the thermal management system 500 or any other thermal management system utilizing a refrigerant loop and configured for use with, for example, an HVAC system for controlling the climate within an enclosed volume (e.g., a vehicle passenger cabin). The refrigerant loop 800 includes many components of the refrigerant loop of the thermal management system 500 described above, including an inside condenser 544, an evaporator 548, an accumulator 552, an electric compressor 556, an outside condenser 560, a reheater/dehydrator 564, and a chiller 568. The refrigerant loop 800 also includes solenoid valves 5901, 5902, 5903, and 5904, and electronic expansion valves 5910, 5912, and 5914. Included as well in the refrigerant loop 800 are pressure-temperature transducers 5801, 5802, 5803, 5804, and 5805. Unless described otherwise below, each of these components operates in the same way as, and may be replaced by the same alternatives as, described above with respect to the thermal management system 500.

The refrigerant loop 800 further includes an HVAC system 804 comprising the inside condenser 544, the evaporator 548, and the HVAC blower 808. The HVAC blower 808 may be any fan or other mechanism configured to circulate air past the inside condenser 544 and the evaporator 548. The HVAC blower 808 may be capable of operating at plurality of speeds, so as to adjust the amount of airflow pas the inside condenser 544 and the evaporator 548. The air circulated by the HVAC blower 808 may be cabin air from the passenger cabin of a vehicle 100 in which the refrigerant loop 800 is utilized, or air obtained from outside a vehicle 100 in which the refrigerant loop 800 is utilized. In some embodiments, a first plurality of air ducts are configured to route intake air from a plurality of sources to the HVAC blower, and a second plurality of air ducts are configured to route conditioned air (air that has been heated or cooled by the inside condenser 544 or the evaporator 548, respectively) to a plurality of destinations, which may include, again, the passenger cabin of a vehicle 100 or an external vent of the vehicle 100. In still other embodiments, the HVAC blower 808 may be configured to run in a first direction to draw air from outside and blow the air into a passenger cabin of a vehicle 100, and to run in a second direction to draw air from the passenger cabin of the vehicle 100 and blow the air outside of the vehicle 100. In yet further embodiments, where the refrigerant loop 800 is utilized in a context other than a vehicle 100, the HVAC blower 808 may be configured to draw air from one or more sources and to blow air back to the one or more sources or to one or more different air exhaust locations.

Also included in the refrigerant loop 800 are T-joints 8601, 8602, 8603, 8604, 8605, 8606, 8607, and 8608, and solenoid valve 5905. These components are utilized in the refrigerant loop 800 to achieve desired refrigerant flow paths, together with the remaining solenoid valves 5901, 5902, 5903, 5904.

Each of the components of the refrigerant loop 800 that is also used in the thermal management system 500 operates in the same way as described above with respect to the thermal management system 500, and may be replaced by the same alternatives as described above with respect to the thermal management system 500.

Various flow paths through the refrigerant loop 800 are possible. Refrigerant passes from the accumulator 552, through the pressure-temperature transducer 5801, and into the compressor 556. The refrigerant then passes through another pressure-temperature transducer 5802 and into T-joint 8603. If the solenoid valve 5901 is closed, then all of the refrigerant passes through the inside condenser 544, the electronic expansion valve 5910, and into the T-joint 8604. If the electronic expansion valve 5910 is closed and the solenoid valve 5901 is open, then all of the refrigerant passes through the inside condenser bypass line and into the T-joint 8604. The refrigerant entering the T-joint 8604 then travels to the T-joint 8605. If the solenoid valve 5905 is closed, the refrigerant circulates through the outside condenser 560 and the pressure-temperature transducer 5805. If the solenoid valve 5905 is open, then some or all of the refrigerant may pass through the outside condenser bypass line that travels through the solenoid valve 5905. In some embodiments, another solenoid valve or other valve for controlling refrigerant flow may be located between the T-joint 8605 and the outside condenser 560, or between the outside condenser 560 and the pressure-temperature transducer 5805, or between the pressure-temperature transducer 5805 and the T-joint 8606. In such embodiments, refrigerant flow through the outside condenser 560 may be controlled using the additional solenoid valve, in addition to or instead of by opening and closing the solenoid valve 5905.

The T-joint 8606 receives refrigerant from the pressure-temperature transducer 5805 and/or the outside condenser bypass line through the solenoid valve 5905, and channels the refrigerant to the T-joint 8607. If the solenoid valve 5903 is open, then refrigerant exiting the T-joint 8607 travels through a bypass line to the T-joint 8601 and then back into the accumulator 552. If the solenoid valve 5903 is open, then the refrigerant passes through the reheater/dehydrator 564 and into the T-joint 8608.

From the T-joint 8608, if the solenoid valve 5902 is open and the solenoid valve 5904 is closed, refrigerant travels through the electronic expansion valve 5912, the evaporator 548, the pressure-temperature transducer 5803, and the T-joint 8602 before reaching the T-joint 8601 and being channeled back into the accumulator 552. On the other hand, if the solenoid valve 5902 is closed and the solenoid valve 5904 is open, then refrigerant circulates through the electronic expansion valve 5914, the chiller 568, the pressure-temperature transducer 5804, and the T-joint 8602 before being channeled back into the accumulator 552.

The location of the pressure-temperature transducers 5801, 5802, 5803, 5804, and 5805 may, in some embodiments, be different than as illustrated in FIG. 8. More or fewer pressure-temperature transducers may be used in a refrigerant loop according to embodiments of the present disclosure than are described in connection with the refrigerant loop 800. Similarly, the solenoid valves 5901, 5902, 5903, 5904, and 5905 may be located at different points along the flow paths with which each is associated, provided that each is positioned so as to control (or at least permit or prevent) the flow of refrigerant through the flow path with which each solenoid valve is associated. Also in some embodiments, one or more of the flow paths depicted in FIG. 8 may be omitted from the refrigerant loop 800, or additional flow paths may be included in the refrigerant loop 800.

At least one benefit of providing both an inside condenser 544 and an outside condenser 560 in the refrigerant loop 800, and of using both the inside condenser 544 and the outside condenser 560 during the same operational mode of the refrigerant loop 800 (e.g., in a heat pump operational mode), is that the size of the outside condenser 560 may be reduced. For example, the outside condenser 560 may be sized to achieve optimum efficiency at a lower mass flow rate of refrigerant therethrough than would previously have been selected. In thermal management system topologies that have both an inside condenser and an outside condenser, typically each is used in a separate operational mode, and each is sized differently (e.g., with respect to the mass flow rate of refrigerant therethrough that yields optimum efficiency) so as to be able to handle predicted extremes for its respective operational mode. In embodiments according to the present disclosure, however, both the inside condenser 544 and the outside condenser 560 are used simultaneously. Rather than sizing each condenser for an expected worst-case scenario, each condenser can be sized for optimum efficiency under the most common expected operating characteristics (e.g., to achieve optimum efficiency at refrigerant mass flow rates that are sufficient for use under common operating conditions), and both condensers can be used simultaneously to sufficiently cool refrigerant under extreme operating characteristics.

For example, the inside condenser 544 permits supplemental cooling or pre-cooling of refrigerant in the refrigerant loop 800, such that if the outside condenser 560 is unable to achieve sufficient cooling, the inside condenser 544 may be used to pre-cool the refrigerant and enable sufficient cooling.

Another benefit of the present disclosure is that each of the inside condenser 544 and the outside condenser 560 can operate at mass flow rates that yield maximum efficiency for each condenser, thus further reducing unnecessary energy consumption. This is not always possible when a condenser must be sized to be able to handle both normal operating characteristics and extreme operating characteristics.

Depending on the operational mode of the refrigerant loop 800, the refrigerant loop 800 may be configured so that all of the refrigerant being circulated through the loop 800 is directed through both the inside condenser 544 and the outside condenser 560. Alternatively, the refrigerant loop 800 may be configured so that all of the refrigerant being circulated through the loop 800 bypasses one or both of the inside condenser 544 and the outside condenser 560.

In addition to allowing refrigerant to bypass the inside condenser 544 and the outside condenser 560, the inside condenser and outside condenser bypass lines provided in the refrigerant loop 800 permit partial-parallel flow of refrigerant through each of the inside condenser 544 and the outside condenser 560, respectively. For example, rather than route all of the refrigerant being circulated through the refrigerant loop 800 through the inside condenser 544, a portion of the refrigerant may be circulated through the inside condenser 544, and the remainder may be circulated through the bypass line that includes the solenoid valve 5901. The amount of refrigerant routed through the inside condenser 544 may be selected to correspond to the most efficient operating range of the inside condenser 544 (if known), or may be selected by determining which proportion of refrigerant flow through the inside condenser 544 and around the inside condenser 544 yields the greatest drop in temperature of the recombined refrigerant. The same principles may be applied to properly split the flow out of the T-joint 8604 into the outside condenser 560 and through the outside condenser bypass line that includes the solenoid valve 5905.

Notably, the use of partial parallel flow as described above in connection with the inside condenser 544 beneficially prevents pressure from building prior to the inside condenser 544 (as may occur if the inside condenser 544 is not sized to handle the high refrigerant mass flow rates desired or necessary for use under a given set of conditions), and may enable a forty percent (or more) increase in the mass flow rate of refrigerant through and around the inside condenser 544 (with the speed at which the compressor 556 is operated held constant), without a significant change in the temperature of the refrigerant exiting the T-joint 8604. This means, for example, that a desired comfort level within the passenger cabin may be achieved more quickly if the speed of the compressor 556 is maintained, or with lower energy consumption if the speed of the compressor 556 is reduced.

Moreover, use of partial parallel flow as described above, as well as use of the inside condenser 544 to provide pre-cooling or supplemental cooling of the refrigerant in the refrigerant loop 800 before the refrigerant is routed through the outside condenser 560 enables greater cooling to be achieved than with use of a single condenser or with the use of two condensers connected in series and sized to handle different mass flow rates (and where no bypass flow paths are available). As a result, the size of one or both condensers may be decreased, and both condensers may be optimally sized to achieve the desired amount of refrigerant cooling.

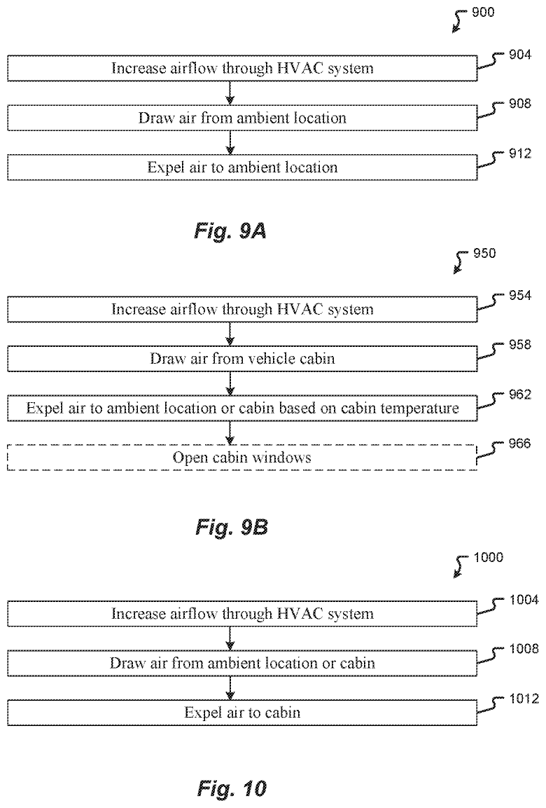

Additional details regarding the operation of the refrigerant loop 800 will now be described in connection with several specific thermal management scenarios and FIGS. 9A-10.

In a first thermal management scenario, a vehicle 100 may be plugged into a charger to fast-charge the battery, and the outside, ambient temperature may be relatively high (as compared, for example, to average temperatures that are comfortable for humans). With reference to FIG. 9A, a method 900 for utilizing the refrigerant loop 800 in this scenario comprises increasing, or causing to be increased, the airflow through the HVAC system 804 and thus over and around the inside condenser 544 (step 904). This may be accomplished, for example, by increasing the speed of the HVAC blower 808. Increasing the airflow over the inside condenser 544 beneficially increases the total heat transfer rate away from the inside condenser 544. In some embodiments, a mechanism other than the HVAC blower may be utilized to achieve increased airflow over the inside condenser. Any device suitable for use in an HVAC system and for causing air to flow past an inside condenser 544 may be utilized to achieve increased airflow.

The method 900 may also comprise configuring, or causing to be configured, the HVAC system 804 to draw outside, ambient air from a location higher and further from the asphalt than the front end of the vehicle 100 (e.g., from a vehicle cowl). Because asphalt radiates heat into the air above the asphalt, drawing air from a location higher on the vehicle 100 and further from the asphalt may yield intake air at a lower temperature than if the air were drawn from a location lower on the vehicle 100 and closer to the asphalt.

The method 900 may also comprise configuring, or causing to be configured, the HVAC system 804 to expel air through one or more vents, flaps, or other opening(s) back to the ambient air outside the cabin of the vehicle 100 (step 912). Such air may be expelled, in some embodiments, underneath a hood of the vehicle 100. In some embodiments, the air may be expelled at a location sufficiently displaced from the intake location to prevent the heated air being expelled from the HVAC system 804 from being drawn back into the HVAC system 804.

The method 950 of FIG. 9B may also be used for dealing with the same thermal management scenario, where the vehicle 100 is plugged into a charger for fast-charging the battery and the outside, ambient temperature is relatively high. The method 950 is particularly well-suited for use when the vehicle 100 has just been used, and the internal cabin temperature is lower than the ambient air temperature. Like the method 900, the method 950 comprises increasing, or causing to be increased, the airflow through the HVAC system 804 and thus over and around the inside condenser 544 (step 954). This may be accomplished, for example, by increasing the speed of the HVAC blower 808. Increasing the airflow over the inside condenser 544 beneficially increases the total heat transfer rate away from the inside condenser 544. In some embodiments, a mechanism other than the HVAC blower may be utilized to achieve increased airflow over the inside condenser. Any device suitable for use in an HVAC system and for causing air to flow past an inside condenser 544 may be utilized to achieve increased airflow.

The method 950 may also comprise configuring, or causing to be configured, the HVAC system 804 to draw air into the HVAC system 804 from the passenger cabin of the vehicle 100 (step 958). By using cooler air from the passenger cabin rather than warmer air from outside the vehicle 100, a greater rate of heat transfer away from the inside condenser 544 may be achieved.

The method 950 may also comprise configuring, or causing to be configured, the HVAC system 804 to expel air to either an ambient location (e.g., outside the vehicle 100) or back into the passenger cabin. Whether the air is expelled to an ambient location or back into the passenger cabin may depend, for example, on the temperature of the air being expelled from the HVAC system 804. For example, if the air being expelled from the HVAC system 804 is at a lower temperature than the outside, ambient air, then use of a recirculation mode (where the air used to extract heat from the inside condenser 544 is expelled back into the cabin of the vehicle 100) may beneficially be used to maintain a reservoir of cooler-than-ambient-temperature air inside the cabin of the vehicle 100, from which air may be drawn into the HVAC system 804. On the other hand, if the air being expelled from the HVAC system 804 is at a higher temperature than the outside, ambient air, then the air may be expelled into the outside, ambient air to preserve the reservoir of cooler-than-ambient-temperature air inside the cabin of the vehicle 100. The temperature of air inside the cabin may be determined using one or more cabin temperature sensors, which may comprise some of the internal sensors 437 described above.

In some embodiments, the method 950 may also comprise opening, or causing to be opened, one or more windows (and/or a sunroof) of the passenger cabin of the vehicle 100 (step 966). The windows and/or sunroof may be opened when a thermal management system control device (such as the device 600) determines, based on data from one or more sensors of the vehicle 100 (such as the internal sensors 437, the infrared sensors 436, and/or other internal and/or external temperature sensors), that introducing fresh ambient air into the cabin of the vehicle 100 will yield greater thermal efficiency. Additionally, one or more vehicle sensors (such as the camera sensors 432 or the infrared sensors 436) may be utilized to determine whether environmental factors, such as rain, snow, or other precipitation, are such that opening of one or more windows and/or the sunroof of the vehicle 100 would be unadvisable, in which instance the one or more windows and/or the sunroof are not opened or caused to be opened.

In a second scenario, a vehicle 100 is plugged into a charger to fast-charge the battery of the vehicle 100, and the outside, ambient air temperature is average or relatively low (as compared, for example, to average temperatures that are comfortable for humans). In this scenario, the inside condenser 544 is used to keep the cabin of the vehicle 100 warm (or to warm up the cabin of the vehicle 100) in preparation for the vehicle 100 to be used when the charging of the battery of the vehicle 100 is complete. A method 1000 for operating a refrigerant loop 800 in such a scenario comprises increasing, or causing to be increased, the airflow through the HVAC system 804 and thus over and around the inside condenser 544 (step 1004). This may be accomplished, for example, by increasing the speed of the HVAC blower 808. Increasing the airflow over the inside condenser 544 beneficially increases the total heat transfer rate away from the inside condenser 544. In some embodiments, a mechanism other than the HVAC blower may be utilized to achieve increased airflow over the inside condenser. Any device suitable for use in an HVAC system and for causing air to flow past an inside condenser 544 may be utilized to achieve increased airflow.

The method 1000 also comprises configuring, or causing to be configured, the HVAC system 804 to draw air from either an ambient location or the passenger cabin of the vehicle 100 (step 1008). Whether the HVAC system 804 is configured to draw air from an ambient location or the cabin of the vehicle 100 may be determined, for example, based on the temperature of the outside, ambient air; the temperature of the air inside the cabin; and the desired temperature of the cabin (which may be determined, for example, based on a factory setting or a user input). If the heat transfer rate from the inside condenser 544 to outside, ambient air drawn into the HVAC system 804 is determined to be sufficient to heat the air to the desired cabin air temperature, the fresh air may be drawn into the HVAC system 804 from outside the vehicle 100. On the other hand, if the ambient air temperature is sufficiently cold that the rate of heat transfer from the inside condenser 544 is not high enough to heat that air to the desired temperature, then air may be drawn into the HVAC system 804 from inside the cabin of the passenger vehicle 100 instead and recirculated, so as to heat and re-heat the air until the desired temperature is reached.

The method 1000 further comprises configuring, or causing to be configured, the HVAC system 804 to expel air into the passenger cabin of the vehicle 100 (step 1012). The air expelled into the passenger cabin of the vehicle 100 will have been heated by the inside condenser 544, and will therefore beneficially warm (or maintain the warmth of) the passenger cabin of the vehicle 100.

As may be appreciated based on the foregoing disclosure, if the HVAC system 804 is configured to receive air from the passenger cabin of the vehicle 100, then the HVAC system 804 will continually add heat to the air within the passenger cabin, and will thus be able to warm the air to a desired temperature even if the outside air temperature is so low as to prevent heating thereof to the desired temperature in a single pass through the HVAC system 804.

Each of the methods 900, 950, and 1000 may also comprise steps of selectively opening an inside condenser bypass flow path (e.g., by selectively opening a solenoid valve 5901) to permit partial parallel flow and achieve a mass flow rate through an inside condenser 544 that will yield optimal efficiency; selectively opening an outside condenser bypass flow path (e.g., by selectively opening a solenoid valve 5905) to permit partial parallel flow and achieve a mass flow rate through an outside condenser 560 that will yield optimal efficiency; and otherwise configuring the various solenoid valves and electronic expansion valves of the refrigerant loop 800 to achieve desired flow of refrigerant through the refrigerant loop 800.

Each of the methods 900, 950, and 1000 may be carried out automatically by a control device 600 or otherwise by a processor executing instructions stored in a memory and generating command signals that are sent to electronic components of the refrigerant loop 800 to cause the steps of the methods 900, 950, and 1000 to be carried out. Alternatively, each of the methods 900, 950, and 1000 may be carried out manually, by the manual movement of one or more switches or other controls by a human operator.

In each of the above scenarios, the user position (e.g., seated in the vehicle 100, merely inside the vehicle 100, approaching the vehicle 100, or leaving the vehicle 100, each as determined by one or more sensors of the vehicle 100) as well as the vehicle status (e.g., battery state of charge, driving mode, ambient temperature, component temperatures) are used to optimize the appropriate level of cabin comfort. For example, if the user is outside the vehicle or leaving it, then cabin comfort can be sacrificed (e.g., by drawing cool air from the vehicle cabin into the HVAC system 804, heating it with the inside condenser 544, and expelling the heated air back into the cabin or outside of the vehicle 100). If the user is inside or approaching the vehicle, on the other hand, the cabin comfort may be improved (e.g., by expelling heated air into the cabin on a cold day).

A number of variations and modifications of the disclosure can be used. It would be possible to provide for some features of the disclosure without providing others.

In some embodiments, one or more aspects of the present disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing one or more aspects of the present disclosure illustrated herein can be used to implement the one or more aspects of this disclosure.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments of the present disclosure include a refrigerant loop for managing thermal energy, comprising: a compressor for compressing refrigerant; an inside condenser; an inside condenser bypass line, the inside condenser bypass line selectively openable to permit varying amounts of refrigerant flow therethrough; an outside condenser having a different size than the inside condenser; and an HVAC system comprising an HVAC blower configured to circulate air over the inside condenser, wherein when a first portion of refrigerant flows through the inside condenser, a second portion of refrigerant simultaneously flows through the inside condenser bypass line.

Aspects of the above refrigerant loop include: an outside condenser bypass line; wherein when a third portion of refrigerant flows through the outside condenser, a fourth portion of refrigerant flows through the outside condenser bypass line; wherein the inside condenser bypass line comprises a selectively openable solenoid valve; wherein a selectively openable electronic expansion valve controls a mass flow rate of refrigerant through the inside condenser; a chiller for transferring heat from coolant circulating through the chiller to refrigerant circulating through the chiller; and wherein the HVAC blower is selectively configurable to operate at different speeds.

Aspects of the above refrigerant loop also include a control device configured to selectively open the inside condenser bypass line, the control device comprising: a control interface; a processor; and a memory storing instructions for execution by the processor, the instructions, when executed by the processor, configured to cause the processor to: receive a signal containing temperature information; determine, based on the temperature information, whether to open the inside condenser bypass line; and transmit, based on the determination and via the control interface, a control signal to a selectively openable solenoid valve of the inside condenser bypass line.

Aspects of the above refrigerant loop further include: wherein the temperature information comprises information about an ambient temperature; and wherein the HVAC system is selectively configurable between a first configuration for expelling air into an enclosed volume and a second configuration for expelling air into an open volume having an ambient temperature.

Embodiments of the present disclosure also include a thermal management system for a vehicle, comprising: a refrigerant loop for circulating refrigerant, the refrigerant loop comprising: a first flow path comprising an inside condenser and an expansion valve; a second flow path for bypassing the first flow path; an evaporator flow path comprising an evaporator; a third flow path comprising an outside condenser; and a compressor; and an HVAC system for conditioning air inside a vehicle passenger cabin, the HVAC system comprising: an HVAC blower for circulating air past the inside condenser and the evaporator.

Aspects of the above thermal management system include: wherein each of the first flow path, and the second flow path is selectively openable; wherein the refrigerant loop is configured to simultaneously circulate a first portion of refrigerant through the first flow path and a second portion of refrigerant through the second flow path; wherein the inside condenser has an optimal operating mass flow rate, and the first portion of refrigerant corresponds to the optimal operating mass flow rate; wherein the refrigerant loop further comprises a fourth, selectively openable flow path for bypassing the outside condenser; wherein the refrigerant loop is configured to simultaneously circulate a third portion of refrigerant through the third flow path and a fourth portion of refrigerant through the fourth, selectively openable flow path; wherein the outside condenser has an optimal operating mass flow rate, and the third portion of refrigerant corresponds to the optimal operating mass flow rate; a coolant loop for circulating coolant to a plurality of heat-producing components, and wherein the refrigerant loop further comprises a chiller flow path comprising a chiller, the chiller configured to extract heat from coolant in the coolant loop; and wherein the first flow path and the second flow path are connected to the refrigerant loop in parallel, and the evaporator flow path and the chiller flow path are connected to the refrigerant loop in parallel.

Embodiments of the present disclosure further include a heat pump comprising: an inside condenser optimized for cooling refrigerant at a first mass flow rate; an outside condenser optimized for cooling refrigerant at a second mass flow rate different than the first mass flow rate; an inside condenser bypass line for routing refrigerant around the inside condenser; an outside condenser bypass line for routing refrigerant around the outside condenser; and a compressor for compressing refrigerant circulating through the heat pump at a third mass flow rate, the third mass flow rate greater than the first mass flow rate; wherein the inside condenser bypass line is selectively openable to permit refrigerant to circulate therethrough at a bypass mass flow rate equal to the difference between the third mass flow rate and the first mass flow rate, so that refrigerant circulates through the inside condenser at the first mass flow rate.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with onboard rechargeable energy storage, including electric vehicles and hybrid electric vehicles.

Examples of processors as referenced herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARIVI926EJS™ processors. A processor as disclosed herein may perform computational functions using any known or future-developed standard, instruction set, libraries, and/or architecture.

What is claimed is:

1. A refrigerant loop for managing thermal energy, comprising:
a compressor for compressing refrigerant;
an inside condenser;
an inside condenser bypass line, the inside condenser bypass line selectively openable to permit varying amounts of refrigerant flow therethrough;
an outside condenser having a different size than the inside condenser; and
an HVAC system comprising an HVAC blower configured to circulate air over the inside condenser,
wherein when a first portion of refrigerant flows through the inside condenser, a second portion of refrigerant simultaneously flows through the inside condenser bypass line.

2. The refrigerant loop of claim 1, further comprising an outside condenser bypass line.

3. The refrigerant loop of claim 2, wherein when a third portion of refrigerant flows through the outside condenser, a fourth portion of refrigerant flows through the outside condenser bypass line.

4. The refrigerant loop of claim 1, wherein the inside condenser bypass line comprises a selectively openable solenoid valve.

5. The refrigerant loop of claim 1, wherein a selectively openable electronic expansion valve controls a mass flow rate of refrigerant through the inside condenser.

6. The refrigerant loop of claim 1, further comprising a chiller for transferring heat from coolant circulating through the chiller to refrigerant circulating through the chiller.

7. The refrigerant loop of claim 1, wherein the HVAC blower is selectively configurable to operate at different speeds.

8. The refrigerant loop of claim 1, further comprising a control device configured to selectively open the inside condenser bypass line, the control device comprising:
a control interface;
a processor; and
a memory storing instructions for execution by the processor, the instructions, when executed by the processor, configured to cause the processor to:
receive a signal containing temperature information;
determine, based on the temperature information, whether to open the inside condenser bypass line; and
transmit, based on the determination and via the control interface, a control signal to a selectively openable solenoid valve of the inside condenser bypass line.

9. The refrigerant loop of claim 8, wherein the temperature information comprises information about an ambient temperature.

10. The refrigerant loop of claim 8, wherein the HVAC system is selectively configurable between a first configuration for expelling air into an enclosed volume and a second configuration for expelling air into an open volume having an ambient temperature.

11. A thermal management system for a vehicle, comprising:
a refrigerant loop for circulating refrigerant, the refrigerant loop comprising:
a first flow path comprising an inside condenser and an expansion valve;
a second flow path for bypassing the first flow path;
an evaporator flow path comprising an evaporator;
a third flow path comprising an outside condenser; and
a compressor; and
an HVAC system for conditioning air inside a vehicle passenger cabin, the HVAC system comprising:
an HVAC blower for circulating air past the inside condenser and the evaporator.

12. The thermal management system of claim 11, wherein each of the first flow path, and the second flow path is selectively openable.

13. The thermal management system of claim 12, wherein the refrigerant loop is configured to simultaneously circulate a first portion of refrigerant through the first flow path and a second portion of refrigerant through the second flow path.

14. The thermal management system of claim 13, wherein the inside condenser has an optimal operating mass flow rate, and the first portion of refrigerant corresponds to the optimal operating mass flow rate.

15. The thermal management system of claim 11, wherein the refrigerant loop further comprises a fourth, selectively openable flow path for bypassing the outside condenser.

16. The thermal management system of claim 15, wherein the refrigerant loop is configured to simultaneously circulate a third portion of refrigerant through the third flow path and a fourth portion of refrigerant through the fourth, selectively openable flow path.

17. The thermal management system of claim 16, wherein the outside condenser has an optimal operating mass flow rate, and the third portion of refrigerant corresponds to the optimal operating mass flow rate.

18. The thermal management system of claim 11, further comprising a coolant loop for circulating coolant to a plurality of heat-producing components, and wherein the refrigerant loop further comprises a chiller flow path comprising a chiller, the chiller configured to extract heat from coolant in the coolant loop.

19. The thermal management system of claim 18, wherein the first flow path and the second flow path are connected to the refrigerant loop in parallel, and the evaporator flow path and the chiller flow path are connected to the refrigerant loop in parallel.

20. A heat pump comprising:
an inside condenser optimized for cooling refrigerant at a first mass flow rate;
an outside condenser optimized for cooling refrigerant at a second mass flow rate different than the first mass flow rate;
an inside condenser bypass line for routing refrigerant around the inside condenser;
an outside condenser bypass line for routing refrigerant around the outside condenser; and
a compressor for compressing refrigerant circulating through the heat pump at a third mass flow rate, the third mass flow rate greater than the first mass flow rate;
wherein the inside condenser bypass line is selectively openable to permit refrigerant to circulate therethrough at a bypass mass flow rate equal to the difference between the third mass flow rate and the first mass flow rate, so that refrigerant circulates through the inside condenser at the first mass flow rate.
